(19) United States
(12) Patent Application Publication
(10) Pub. No.: US 2009/0245221 A1
(43) Pub. Date: Oct. 1, 2009

(54) MULTIRADIO OPERATION USING INTERFERENCE REPORTING

(75) Inventor: Antti Piipponen, Tampere (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/059,177

(22) Filed: Mar. 31, 2008

(51) Int. Cl. H04J 3/00

(52) U.S. Cl. 370/343

(57) ABSTRACT

A system for managing a plurality of wireless communication mediums that may operate in a substantially simultaneous manner. The plurality of wireless communication mediums may be supported by one or more radio modules in the same device. Parameters related to applications, device and/or wireless communication mediums may be used to create operational schedule(s) for the plurality of wireless communication mediums that dictate when each medium is allowed to be active. At least one of the plurality of wireless communication mediums may support co-located reporting, and this functionality may used in concert with the operational scheduling in order to reduce potential conflicts while also reducing resource consumption in other devices.

### BACKGROUND

1. Field of Invention

The present invention relates to a system for managing two or more concurrently active communication mediums in an apparatus, and more specifically, to the utilization of interference reporting as a part of a communication management strategy in the apparatus.

2. Background

Wireless communication devices (WCD) continue to proliferate due, in part, to technological advances that have improved both Quality of Service (QoS) and functionality. As a result, these devices have become commonplace for both personal and business use, allowing users to transmit and receive voice, text and graphical data from various locations. The wireless mediums by which these transactions may be executed span different frequencies and ranges.

Cellular networks may facilitate communication over large geographic areas. Network technologies are typically divided into generations, starting in the late 1970s to early 1980s with first generation (1G) analog handsets that provided baseline voice communication, to more modern digital handsets. Global System for Mobile communications (GSM) is an example of a widely employed 2G digital cellular network communicating in the 900 MHz/1.8 GHz bands in Europe and at 850 MHz and 1.9 GHz in the United States. GSM may provide voice communication and also supports the transmission of text via the Short Messaging Service (SMS). SMS may transmit/receive text messages of up to 160 characters, while providing data transfer to packet networks, ISDN and POTS users at 9.6 Kbps. An enhanced messaging service (Multimedia Messaging Service or “MMS”) allows for the transmission of sound, graphics and video files in addition to simple text. Soon emerging 3G and 4G technologies such as Digital Video Broadcasting for Handheld Devices (DVB-H) will make streaming digital video, and other similar content, available via direct transmission to a WCD. While these long-range networks have been widely employed for transmitting and receiving data, due to cost, traffic and legislative concerns, these networks may not be appropriate for all data applications.

Short-range wireless communication may provide solutions that avoid some of the problems seen in large cellular networks. Bluetooth™ is an example of a short-range wireless technology quickly gaining acceptance in the marketplace. A 1 Mbps Bluetooth™ radio may transmit and receive data at a rate of 720 Kbps within a range of 10 meters, and may transmit up to 100 meters with additional power boosting. Enhanced data rate (EDR) technology may also enable maximum asymmetric data rates of 1448 Kbps for a 2 Mbps connection and 2178 Kbps for a 3 Mbps connection. A plurality of devices within operating range of each other may automatically form a network group called a “piconet.” Any device may be promoted to the master of the piconet, allowing it to interact with up to seven “active” slaves and 255 “parked” slaves. Active slaves exchange data based on the clock timing of the master. Parked slaves may monitor a beacon signal in order to stay synchronized with the piconet. Devices may switch between active communication and other exemplary modes including, for example, resource conservation modes. In addition to Bluetooth™, other short-range wireless mediums include ultra low power Bluetooth™ (ULP-BT), WLAN (e.g., “Wi-Fi” access points communicating in accordance with IEEE 802.11), WUSB, UWB, ZigBee (802.15.4, 802.15.4a), and UHF RFID.

Device manufacturers have also begun to incorporate Near Field communication technologies for providing enhanced data input/output functionality (e.g., components and software for performing close-proximity wireless information exchanges). For example, sensors and/or scanners in a device may be used to read visual or electronic information. An exemplary scenario may involve a user holding a WCD in proximity to a target, aiming a device at an object (e.g., to take a picture), sweeping a device over a printed tag or document, etc. Exemplary Near Field communication technologies may include radio frequency identification (RFID), Infra-red (IR) communication, optical character recognition (OCR) and various other types of visual, electronic and magnetic scanning executed by various components, such as sensors, charge-coupled devices (CCD), etc.

Emerging devices now incorporate many of the previously discussed exemplary features in an attempt to create powerful, “do-all” tools. Devices incorporating long-range, short-range and NFC resources often include multiple mediums for each category. This may allow a WCD to flexibly adjust to its surroundings, for example, communicating both with a WLAN access point and a Bluetooth™ communication accessory, possibly at the same time.

Given the array of features that may be included a device, it is foreseeable that a user will need to employ a WCD to its full potential when replacing other productivity-related devices. For example, a fully-functioned WCD may replace traditional tools such as individual phones, facsimile machines, computers, storage media, etc. that may be cumbersome to integrate, transport, etc. In at least one use scenario, a WCD may communicate over numerous different wireless mediums simultaneously. A user may utilize multiple peripheral Bluetooth™ devices (e.g., headset, keyboard, etc.) while having a voice conversation over GSM and interacting with a WLAN access point in order to access the Internet. Problems may occur when concurrent transactions interfere with each other. Even if communication mediums do not share identical operating frequencies, extraneous interference can occur. Further, it is possible for the combined effect of two or more concurrently operating radios to cause intermodulation in other bandwidths due to harmonic effects. These disturbances may cause errors resulting in the retransmission of lost packets, and the overall degradation of performance for active communication mediums.

Existing communication management strategies may, in some instances, attempt to adjust the operation of resources supporting a wireless communication medium in order to avoid situations that could reduce quality of service (QoS). These techniques may attempt to avoid communication conflicts through a reactive strategy of adjusting operation in response to the detection of potentially interfering signals. However, conflicts may already be occurring at the instant a “foreign” signal is detected. This means that overall QoS for an apparatus may already be negatively impacted by the time any corrective action is implemented. As a result, current systems cannot proactively manage a plurality of co-existing wireless communication mediums operating, for example, in the same apparatus, before actual interference occurs.

### SUMMARY

The present invention, in accordance with at least one embodiment, may manage a plurality of wireless communication mediums that may operate in a substantially simultaneous manner. The plurality of wireless communication mediums may be supported by one or more radio modules in the same device. A variety of information related to applications, device and/or wireless communication medium parameters may be used to create operational schedule(s) for the plurality of wireless communication mediums that dictate when each medium is allowed to be active. At least one of the plurality of wireless communication mediums may support CLI reporting, and this functionality may used in concert with the operational scheduling in order to reduce potential conflicts while also reducing resource consumption at least in other devices.

For example, a control entity in the device may receive information from active applications on the device regarding messages to be sent, the current state of resources in the device, the particular communication mediums that are currently active, etc., and may in turn formulate operational schedule information including one or more time periods during which each active wireless communication medium may be active. This schedule may be conveyed to the one or more radio modules in order to facilitate operation in accordance with the schedule. Any wireless communication mediums that support CLI reporting may also participate in this scheduling operation, resulting in one or more activity periods for the CLI reporting mediums.

In various embodiments the present invention, the device may transmit at least some of the activity period information, indicating one or more periods of time during which activity may be allowed to disallowed, from the operational schedule(s) to other devices as a component of CLI reporting. This information may, for example, pertain to periods of time when CLI medium operation is allowed/disallowed, or periods of time when the operation of other mediums that may possibly conflict with CLI mediums are allowed/disallowed. The receiving device (e.g., another WCD, an access point, etc.) may then utilize this information to avoid communicating during times where potential conflicts due to interference may occur. This operational strategy may, in accordance with at least one embodiment of the present invention, both reduce the potential for communication errors in proximately operating devices and help to conserve resources in at least the receiving device since communication may be prevented during periods where conflicts may occur, reducing the number of packets that must be retransmitted.

Moreover, the various embodiments of the present invention illustrated above are only examples. The present invention is not limited to these specific exemplary configurations, as it should be appreciated that corresponding embodiments may apply to other aspects as well.

### DESCRIPTION OF DRAWINGS

The present invention may be understood from the following detailed description of various exemplary embodiments, taken in conjunction with appended drawings, in which:

FIG. 1 discloses an exemplary wireless operational environment, including wireless communication mediums with different effective ranges.

FIG. 2 discloses a modular description of an exemplary wireless communication device usable with at least one embodiment of the present invention.

FIG. 3 discloses an exemplary structural description of the wireless communication device previously described with respect to FIG. 2.

FIG. 4A discloses an exemplary operational description of a wireless communication device utilizing a wireless communication medium in accordance with at least one embodiment of the present invention.

FIG. 4B discloses an operational example wherein interference occurs when utilizing multiple radio modems simultaneously within the same wireless communication device.

FIG. 5A discloses an example of single mode radio modules usable with at least one embodiment of the present invention.

FIG. 5B discloses an example of a multimode radio module usable with at least one embodiment of the present invention.

FIG. 6A discloses an exemplary structural description of a wireless communication device including a multiradio controller in accordance with at least one embodiment of the present invention.

FIG. 6B discloses a more detailed structural diagram of FIG. 6A including the multiradio controller and the radio modems.

FIG. 6C discloses an exemplary operational description of a wireless communication device including a multiradio controller in accordance with at least one embodiment of the present invention.

FIG. 7A discloses an exemplary structural description of a wireless communication device including a multiradio control system in accordance with at least one embodiment of the present invention.

FIG. 7B discloses a more detailed structural diagram of FIG. 7A including the multiradio control system and the radio modems.

FIG. 7C discloses an exemplary operational description of a wireless communication device including a multiradio control system in accordance with at least one embodiment of the present invention.

FIG. 8A discloses an exemplary structural description of a wireless communication device including a distributed multiradio control system in accordance with at least one embodiment of the present invention.

FIG. 8B discloses a more detailed structural diagram of FIG. 8A including the distributed multiradio control system and the radio modems.

FIG. 8C discloses an exemplary operational description of a wireless communication device including a distributed multiradio control system in accordance with at least one embodiment of the present invention.

FIG. 9A discloses an exemplary structural description of a wireless communication device including a distributed multiradio control system in accordance with an alternative embodiment of the present invention.

FIG. 9B discloses a more detailed structural diagram of FIG. 9A including the distributed multiradio control system and the radio modems.

FIG. 9C discloses an exemplary operational description of a wireless communication device including a distributed multiradio control system in accordance with the alternative embodiment of the present invention disclosed in FIG. 9A.

FIG. 10 discloses an exemplary information packet usable with at least one embodiment of the present invention.

FIG. 11A discloses an example of basic inter-apparatus communication including an access point and two remote apparatuses.

FIG. 11B discloses an example of potential problems that may arise in inter-apparatus communication when the devices are communicating concurrently using conflicting wireless communication mediums.

FIG. 12 discloses an example of implementing interference reporting with multiradio control in accordance with at least one embodiment of the present invention.

FIG. 13A discloses an example of inter-apparatus communication including the implementation of multiradio and interference reporting in accordance with at least one embodiment of the present invention.

FIG. 13B discloses an effect of the implementation of multiradio and interference reporting in accordance with at least one embodiment of the present invention.

FIG. 14 discloses a flowchart for an exemplary process for managing communication resources in accordance with at least one embodiment of the present invention.

### DESCRIPTION OF PREFERRED EMBODIMENT

While the invention has been described below in terms of multiple exemplary embodiments, various changes can be made to any or all of these embodiments without departing from the spirit and scope of the invention, as described in the appended claims.

### I. Wireless Communication Over Different Communication Networks

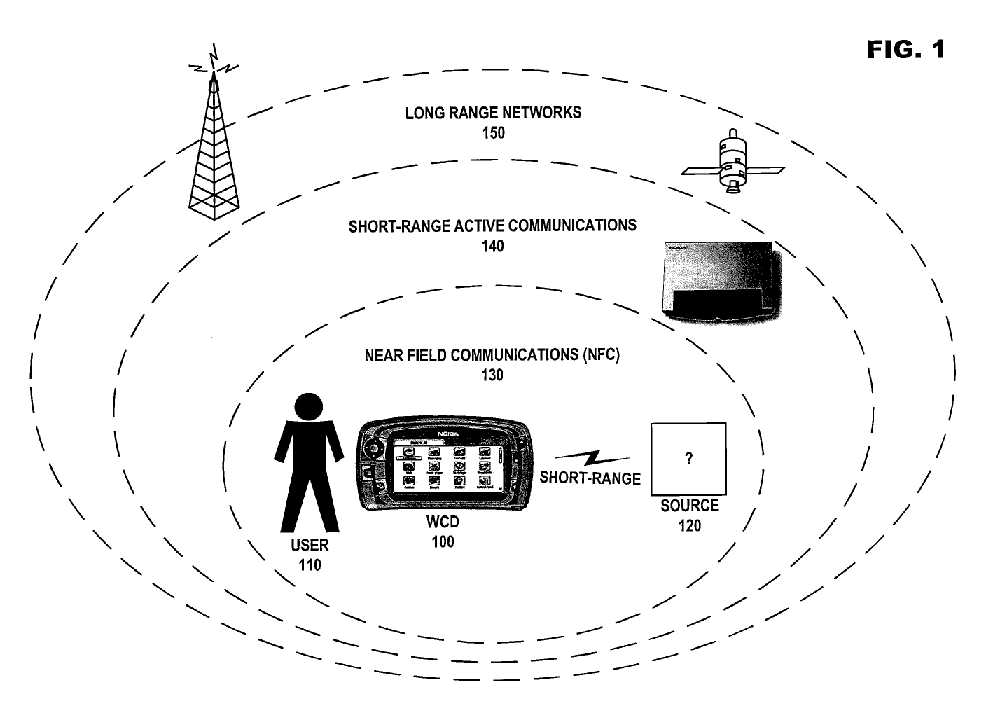

A WCD may both transmit and receive information over a wide array of wireless communication networks, each with different advantages regarding speed, range, quality (error correction), security (encoding), etc. These characteristics will dictate the amount of information that may be transferred to a receiving device and the duration of the information transfer. FIG. 1 includes an example of a WCD and how it interacts with various types of wireless networks.

In the example of FIG. 1, user 110 may possess WCD 100 (e.g., holding device, in a pocket, handbag, etc.). This device may be anything from a basic device to a more complex apparatus such as a wirelessly enabled palmtop or laptop computer. Near Field Communication (NFC) 130, in accordance with at least one embodiment of the present invention, may include various transponder-type interactions wherein normally only the scanning device is powered. WCD 100 may scan source 120 via short-range communication. A transponder in source 120 may use the energy and/or clock signal contained within the scanning signal, as in the case of RFID communication, to respond with data stored in the transponder. Technologies of this type usually have an effective transmission range on the order of ten feet, and may be able to deliver stored data in amounts from a bit to over a megabit (or 125 Kbytes) relatively quickly. These features make such technologies well suited for identification purposes, such as in receiving names, ID numbers, a security key code, an account number for a credit or debit transaction, etc.

The transmission range may be extended if powered communication is available in all participating devices. Short-range active communication 140 may include applications wherein the sending and receiving devices are both active (e.g., have their own power sources). For example, user 110 may enter the transmission range of an access point using Bluetooth™, WLAN, UWB, WUSB, etc. In the case of Bluetooth™, a piconet may automatically be established to transmit information to WCD 100 (possessed by user 110). The amount of information to be conveyed is unlimited, except that it must all be transferred in the time when user 110 is within effective transmission range of the access point. Due to the higher complexity of these wireless networks, additional time may also required to negotiate an initial connection with WCD 100, which may be increased if multiple devices are queued for service in the area proximate to the access point. The transmission range of these networks depends on the technology in use, and may be from some 30 ft. to over 300 ft. with additional power boosting.

Long-range networks 150 may provide virtually uninterrupted communication coverage for WCD 100. Land-based radio stations or satellites may be used to relay wireless messages worldwide. However, long-range network signals are sometimes not available inside certain structures, and the use of these systems is often charged on a per-minute basis to user 110, not including additional charges for data transfer (e.g., wireless Internet access). Further, these systems are regulated by national/international governmental bodies, which may cause additional overhead for both the users and providers that may make their use more cumbersome.

### II. Wireless Communication Device

As previously described, various embodiments of the present invention may be implemented using different communication-enabled apparatuses. It therefore becomes important to understand the variety of communication tools available to user 110 before exploring the details of the present invention. For example, in the case of a cellular telephone or other handheld wireless devices, the integrated data handling capabilities of the device may play an important role in facilitating transactions between the transmitting and receiving devices.

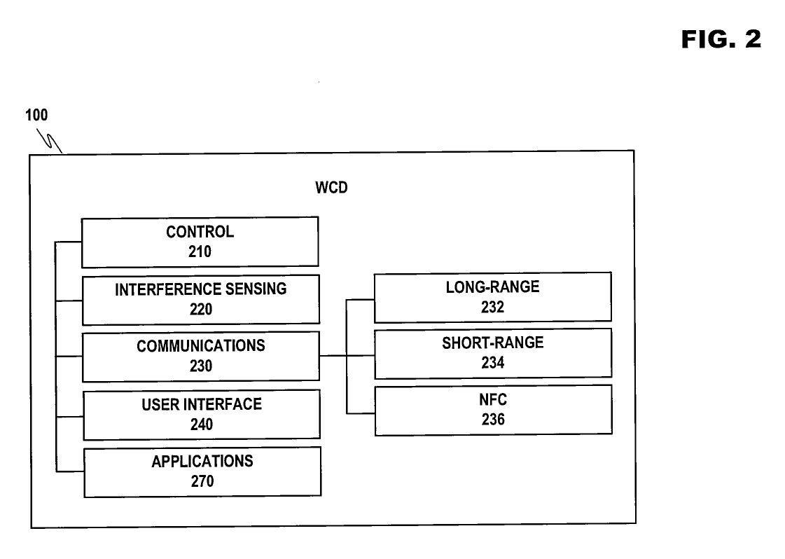

FIG. 2 discloses an exemplary modular layout for an apparatus that may be usable in accordance with at least one embodiment of the present invention. In this example, WCD 100 has been shown in terms of multiple functional modules. These exemplary functions may be executed by the various combinations of software and/or hardware components discussed below.

Control module 210 may regulate the operation of the apparatus. Inputs may be received from various other modules included within WCD 100. For example, interference sensing module 220 may utilize various detection techniques known in the art to sense sources of environmental interference (e.g., other signals or electromagnetic fields) within the effective transmission range of the wireless communication device. Control module 210 may then interpret this data, and in response, may issue commands to the other modules in WCD 100.

Communications module 230 may incorporate all of the wired and/or wireless communication aspects of WCD 100. As shown in FIG. 2, communications module 230 may include, for example, long-range communications module 232, short-range communications module 234 and Near Field communication (NFC) module 236. Communications module 230 may utilize one or more sub-modules to receive different types of communication from both local and remote sources, and to transmit data to recipient devices within the transmission range of WCD 100. Communications module 230 may be triggered by control module 210, or by control resources local to the module responding to received messages, environmental influences and/or other proximate devices.

User interface module 240 may include visual, audible and tactile elements which allow user 110 to receive data from, and enter data into, an apparatus. The data entered by user 110 may be interpreted by control module 210 in order to affect activity in WCD 100. User-inputted data may also be transmitted by communications module 230 to other apparatuses. Information may also be received from proximate apparatuses via communications module 230 for presentment by interface module 240, possibly in conjunction with control module 210.

Applications module 250 may incorporate other hardware and/or software on WCD 100. These applications may include sensors, interfaces, utilities, interpreters, data processing applications, communication tools, etc. Programs within application module 250 may be invoked, for example, by control module 210 in order to read data provided by the various modules, and in turn supply, information to the same or other modules making up WCD 100.

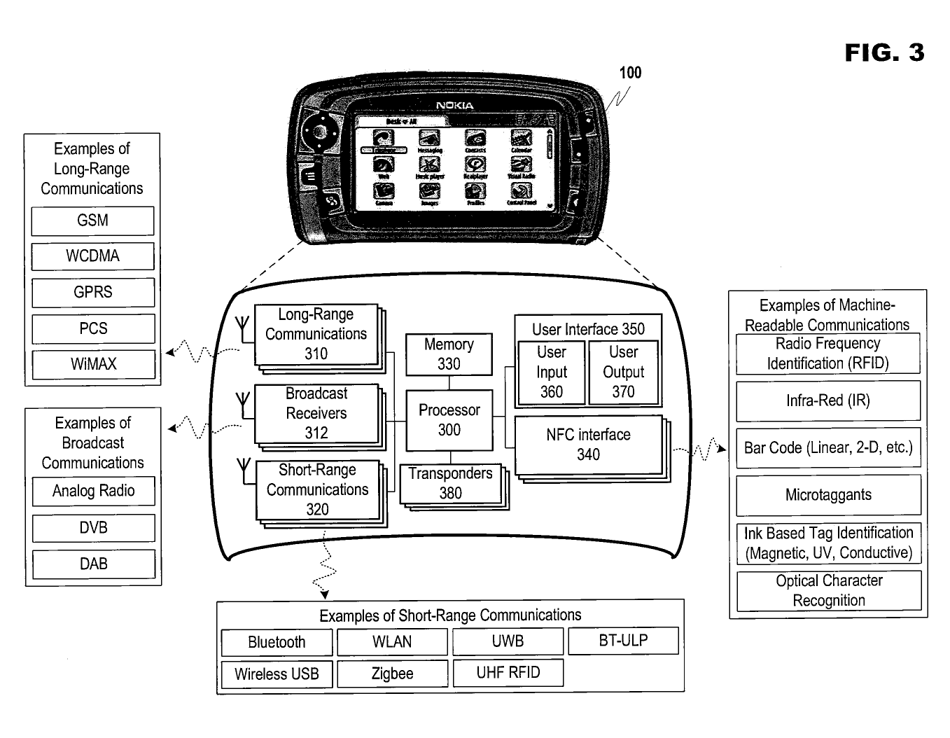

FIG. 3 discloses an exemplary structural layout of WCD 100 according to an embodiment of the present invention that may be used to implement the functionality of the modular system previously described in FIG. 2. Processor 300 may control overall apparatus operation. As shown in FIG. 3, processor 300 may be coupled to one or more communications sections 310, 320 and 340. Processor 300 may include one or more microprocessors that are capable of executing software instructions or accessing data stored, for example, in memory 330.

Memory 330 may include removable and/or fixed storage components composed of one or more random access memories (RAM), read only memories (ROM), and/or flash memories, and may store information in the form of data and software components (also referred to herein as modules). Further, removable media may include the electronic, magnetic or optical varieties that are currently used or being developed in the art. The data stored by memory 330 may be associated with particular software components. In addition, this data may be associated with databases, such as a bookmark database or a business database for scheduling, email, etc.

Software stored in memory 330 may include instructions that are executable by processor 300. Various types of software components may be stored in memory 330, such as software components that form an operating system for WCD 100 and control operation of various subsystems like communication sections 310, 320 and 340. Memory 330 may also store other software components including internet browsers, security elements like a firewall, user interfaces and communication utilities (e.g., email, messaging) required to support WCD 100.

Long-range communications 310 may include functionality pertaining to the exchange of information over large geographic areas (such as cellular networks). These communication methods may include technologies from the previously described 1G to 4G. In addition to basic voice communication (e.g., via GSM), long-range communications 310 may operate to establish data communication sessions, such as General Packet Radio Service (GPRS) sessions and/or Universal Mobile Telecommunications System (UMTS) sessions. Also, long-range communications 310 may further operate to transmit and receive messages, such as short messaging service (SMS) messages and/or multimedia messaging service (MMS) messages.

As a subset of long-range communications 310, or alternatively operating as an independent module separately connected to processor 300, broadcast receiver 312 may allow WCD 100 to receive transmission messages via mediums such as Digital Video Broadcast for Handheld Devices (DVB-H). These broadcasts may contain text, audio or video information and may be encoded so that only certain receiving devices may access the transmission content. For instance, WCD 100 may receive broadcasts including both content and access information in the broadcast signal that may be used to determine if an apparatus is permitted to view the content.

Short-range communications 320 may be responsible for functions involving the exchange of information across short-range wireless networks. As described above, and as disclosed in FIG. 3, examples of short-range communications 320 are not specifically limited to Bluetooth™, Wireless local area networks (WLAN), Ultra Wide Band (UWB), Ultra-Low Power Bluetooth™, Wireless Universal Serial Bus (WUSB), Zigbee and Ultra-High Frequency Radio Frequency Identification (UHF-RFID) connections and other technologies under development that may operate similarly to the above examples. Accordingly, short-range communications 320 may perform functions related to the establishment of short-range connections, as well as processing related to the transmission and reception of information via such connections.

Near Field communications (NFC) interface 340, a subsystem of WCD 100 also disclosed in FIG. 3, may provide functionality related to the short-range scanning of machine-readable data. For example, processor 300 may activate components in NFC 340 to generate RF signals for activating an RFID transponder, and may in turn control the reception of signals from an RFID transponder. Other short-range scanning methods for reading machine-readable data that may be supported by the NFC 340 are not limited to Infra-red (IR), linear and two-dimensional (e.g., 2-D or QR) bar codes, recognition devices for optically, electronically or magnetically reading magnetic, UV, conductive or other types of coded data that may be provided using suitable ink and/or media. In order for NFC 340 to scan the aforementioned exemplary types of machine-readable data, input devices may include optical detectors, magnetic detectors, CCDs or other sensors known in the art for interpreting machine-readable information.

As disclosed in FIG. 3, user interface 350 may also interact with processor 300. User interface 350 may facilitate the exchange of information with user 110. FIG. 3 shows that user interface 350 may include user input 360 and user output 370. User input 360 may include one or more components that allow a user to input information. Examples of such components may include keypads, touch screens, and microphones. User output 370 allows a user to receive information from the device. Thus, user output portion 370 may include various components, for example, a display, light emitting diodes (LED), tactile emitters and one or more audio speakers. Exemplary displays may include liquid crystal displays (LCDs), and other video displays.

WCD 100 may further include one or more transponders 380. This may be an essentially passive device that may be hard-coded, preprogrammed or programmed by processor 300 with information to be delivered in response to a scan from an outside source. For example, an RFID scanner mounted in an entryway may continuously emit radio frequency waves. When an apparatus containing transponder 380 passes near the scanner, the transponder may become energized, and may respond with information identifying the device, the person, etc. In addition, a scanner may be mounted (e.g., as previously discussed above with regard to examples of NFC 340) in WCD 100 so that it may read information from proximately-located transponders.

The hardware that corresponds to communications sections 310, 312, 320 and 340 may provide for the transmission and reception of signals. Accordingly, these portions may include components (e.g., electronics) that perform functions, such as modulation, demodulation, amplification, and filtering. These subsystems may be locally controlled, or controlled by processor 300 in accordance with software communication components stored in memory 330.

The elements shown in FIG. 3 may be constituted and/or coupled in accordance with various techniques to produce the functionality described in FIG. 2. One such technique involves linking discrete hardware components corresponding to processor 300, communications sections 310, 312 and 320, memory 330, NFC 340, user interface 350, transponder 380, etc. via one or more wired and/or wireless bus interfaces. Alternatively, any and/or all of the individual components may be replaced by an integrated circuits such as programmable logic devices, gate arrays, application specific integrated circuits (ASIC), multi-chip modules, etc. programmed to replicate the functions of the various stand-alone devices. Each of the components may be coupled to a power source, such as a removable and/or rechargeable battery (not shown).

User interface 350 may interact with communication utility software components, also contained in memory 330, which may provide for the establishment of service sessions via long-range communications 310 and/or short-range communications 320. The communication utilities component may include various routines that allow the reception of services from remote devices facilitated by programming languages such as Wireless Application protocol (WAP), Hypertext Markup Language (HTML) variants like Compact HTML (CHTML), and other program languages/protocols that may be used to support functions and data on WCD 100.

### III. Exemplary Operation of a Wireless Communication Device Including Potential Interference Problems Encountered.

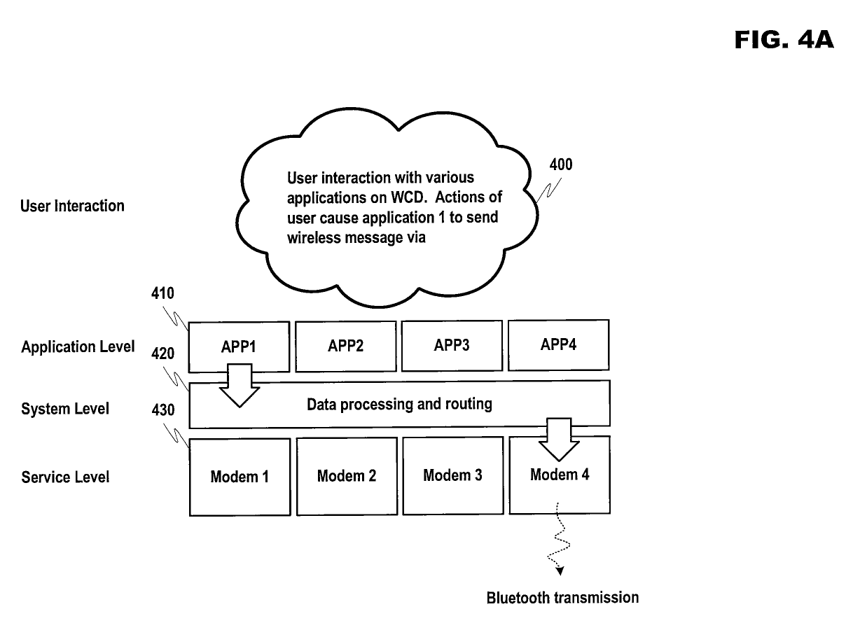

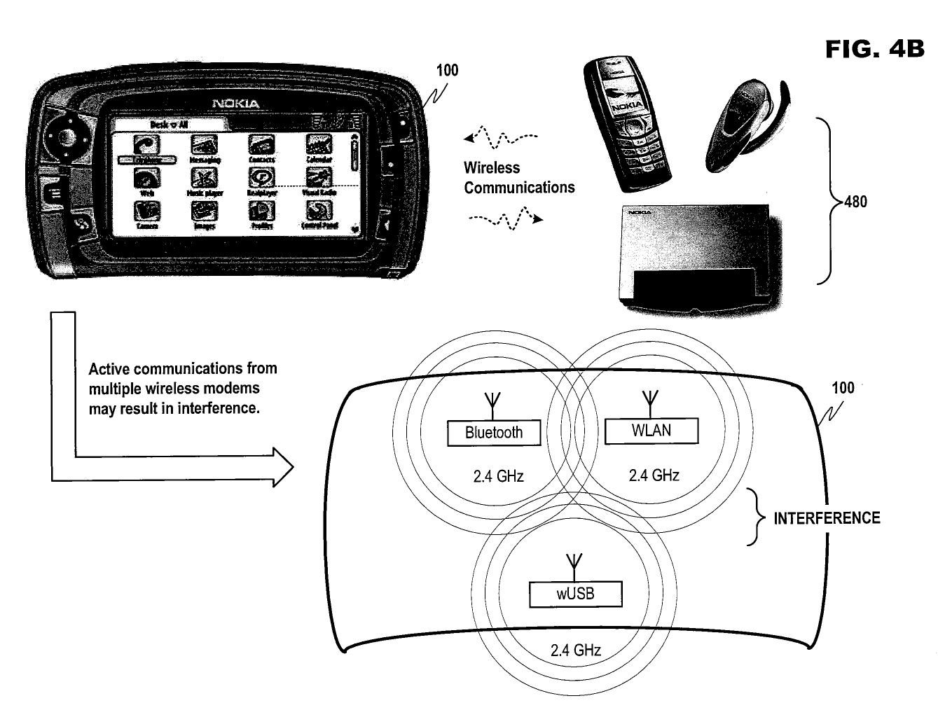

FIG. 4A discloses a stack approach to understanding the operation of WCD 100 in accordance with at least one embodiment of the present invention. At the top level 400, user 110 may interact with WCD 100. The interaction may involve user 110 entering information via user input 360 and receiving information from user output 370 in order to activate functionality in application level 410. In the application level, programs related to specific functionality within the device may interact with both user 110 and the system level. These programs may include applications for visual information (e.g., web browser, DVB-H receiver, etc.), audio information (e.g., cellular telephone, voice mail, conferencing software, DAB or analog radio receiver, etc.), recording information (e.g., digital photography software, word processing, scheduling, etc.) or other information processing. Actions initiated at application level 410 may require information to be sent from or received into WCD 100. In the example of FIG. 4A, data is requested to be sent to a recipient device via Bluetooth™ communication. As a result, application level 410 may then access resources in the system level to initiate the required processing and routing of data.

System level 420 may process data requests and route the data for transmission. Processing may include, for example, calculation, translation, conversion and/or packetizing the data. The processed data may then be routed to an appropriate communication resource in the service level. If the desired communication resource is active and available in the service level 430, the data packets may be routed to a radio modem for delivery via a communication medium. If wireless communication is appropriate or required in order to send the data packets, there may be a plurality of modems operating using different wireless mediums. For example, in FIG. 4A, modem 4 is activated and able to send packets using Bluetooth™ communication. However, a radio modem (as a hardware resource) need not be dedicated only to a specific wireless medium, and may be used for different types of communication depending on the requirements of the wireless medium and the hardware characteristics of the radio modem.

FIG. 4B discloses a scenario wherein the above described operational example may cause more than one radio modem to become active at relatively the same time. In this case, WCD 100 may be transmitting and receiving information via wireless communication over a multitude of mediums. WCD 100 may be interacting with various linked devices such as those shown at 480. These devices may include, for example, handsets communicating via GSM, headsets communicating via Bluetooth™, Internet access points communicating via WLAN, etc.

Problems may occur when some or all of these communications are carried on simultaneously. As further shown in FIG. 4B, multiple modems operating simultaneously may cause interference for each other. Such a situation may be encountered when WCD 100 is communicating with more than one external device (as previously described). In an exemplary extreme case, devices with modems simultaneously communicating via Bluetooth™, WLAN and WUSB would encounter substantial overlap since all of these wireless mediums operate in the 2.4 GHz band. The interference denoted in FIG. 4B may cause packets to be lost, and therefore, the need for packet retransmission. The retransmission of lost packets requires that future time slots be used to retransmit this information, and therefore, overall communication performance will be negatively impacted, if not completely lost, as continual errors disrupt the wireless link.

### IV. Radio Modem Signal Control in a Wireless Communication Device.

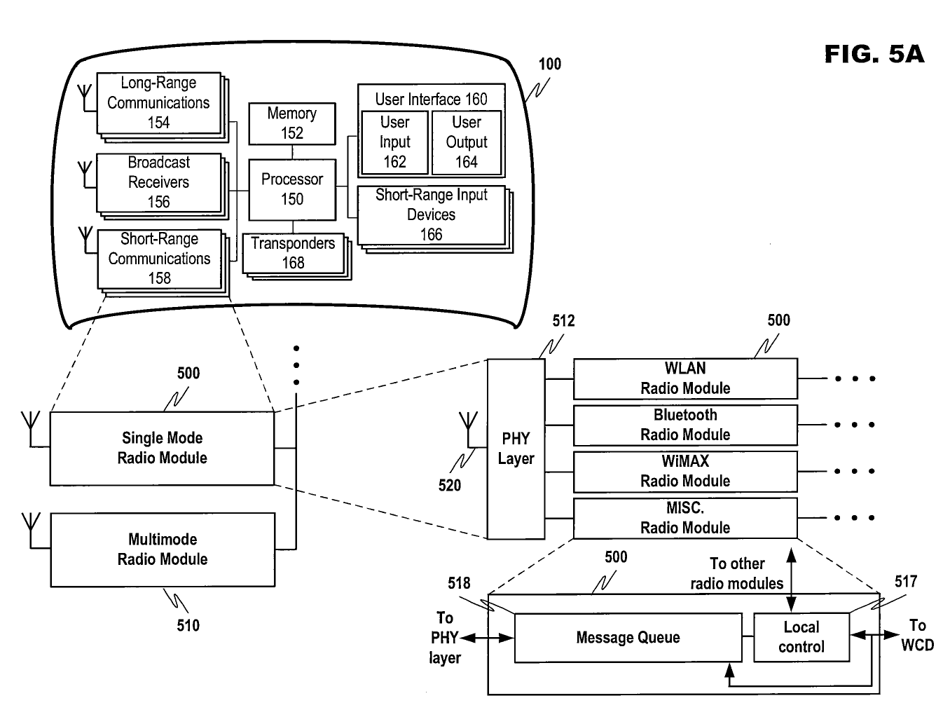

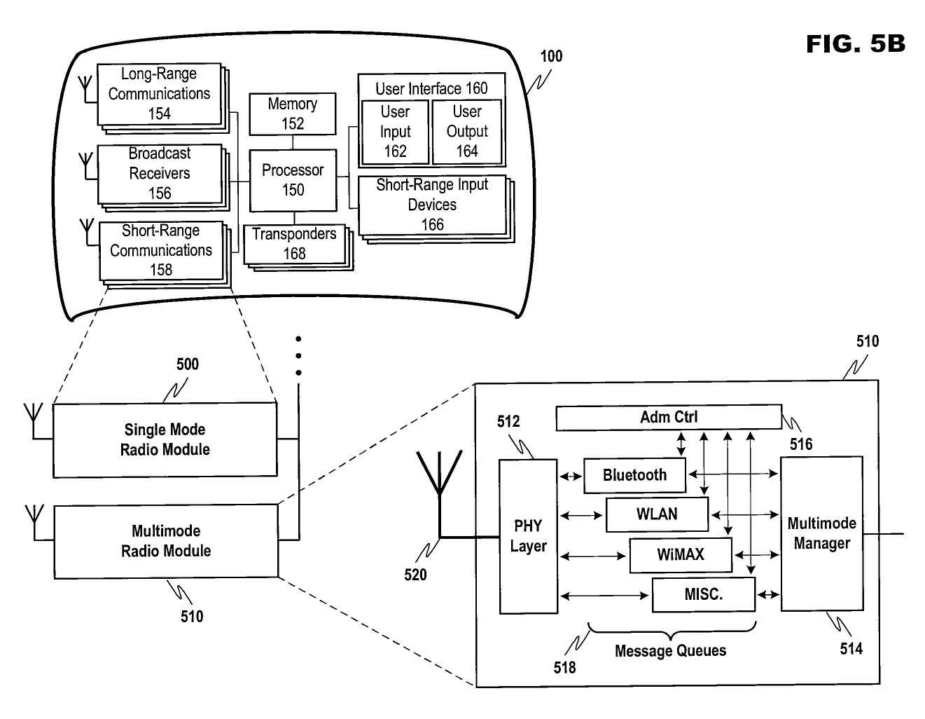

Examples of radio modules that may be utilized in implementing various exemplary embodiments of the present invention are shown in FIG. 5A. The type(s) of radio module implemented in WCD 100 may depend on the requirements of, or conversely, on limitations in the apparatus such as space and/or power limitations. Example radio module 500 is a single mode radio module and radio module 510 is a multimode radio module, which is explained further in FIG. 5B. Single mode radio module 500 may only support one wireless communication medium at a time (e.g., a single mode radio module configured to support Bluetooth™) and may share physical resources (e.g. physical layer 512) such as a common antenna 520 or an antenna array and associated hardware. Alternatively, according to at least one embodiment of the present invention, each single mode radio module 500 may be configured with its own dedicated physical resources for operation so that, for example, a dedicated antenna (not shown) may be provided to each of the single mode radio modules 500 shown in FIG. 5A.

Since all of the single mode radio modules may share the resource of physical layer 512 as depicted in FIG. 5A, some sort of control may exist in order to manage how each single mode radio module 500 uses the PHY resources. Local controller 517 may therefore be included in each radio modem to control the usage of PHY layer 512. Local controller 517 may take message information as an input from other components within WCD 100 that need to send messages via single mode radio module 500 and also information from other single mode radio modules 500 as to their current state. This current state information may include, for example, priority level, active/inactive state, number of messages pending, duration of communication, etc. Local controller 517 may use this data to control the release of messages from message queue 518 to PHY layer 512, or further, to control the quality level of the messages sent from message queue 518 in order to conserve resources for other wireless communication mediums. The local control in each single mode radio module 500 may take the form of, for example, a schedule for utilization of a wireless communication medium implemented in the radio module.

An example of a multimode radio module 510 is now disclosed in FIG. 5B. Multimode radio module 510 may include local control resources for managing each “radio” (e.g., software based radio control stacks) attempting to use PHY resources in multimode radio module 510. In this example, multimode radio module 510 includes at least three radio stacks or radio protocols (labeled Bluetooth, WLAN and WiMAX in FIG. 5B) that may share the PHY layer resources (e.g., hardware resources, antenna, etc.) of multimode radio module 510. Local control resources may include, for example, an admission controller (Adm Ctrl 516) and a multimode controller (Multimode Manager 514). These resources may be embodied as software and/or in a hard-coded/hardware form in a radio modem interface. The radio modem interface may be its own module coupled to, or alternatively embedded in, multimode radio module 510.

Admission control 516 may act as a gateway for multimode radio module 510 by filtering out different wireless communication medium requests received from the operating system of WCD 100 or from multimode radio module 510 that may cause conflicts in multimode radio module 510. The conflict data, and possibly operational schedules for other radio modules, may be received in multimode manager 514. This operational information may then be used to formulate schedules, such as a schedule for utilization of each wireless communication medium, controlling the release of messages for transmission from the various message queues 518.

### V. A Wireless Communication Device Including a Multiradio Controller.

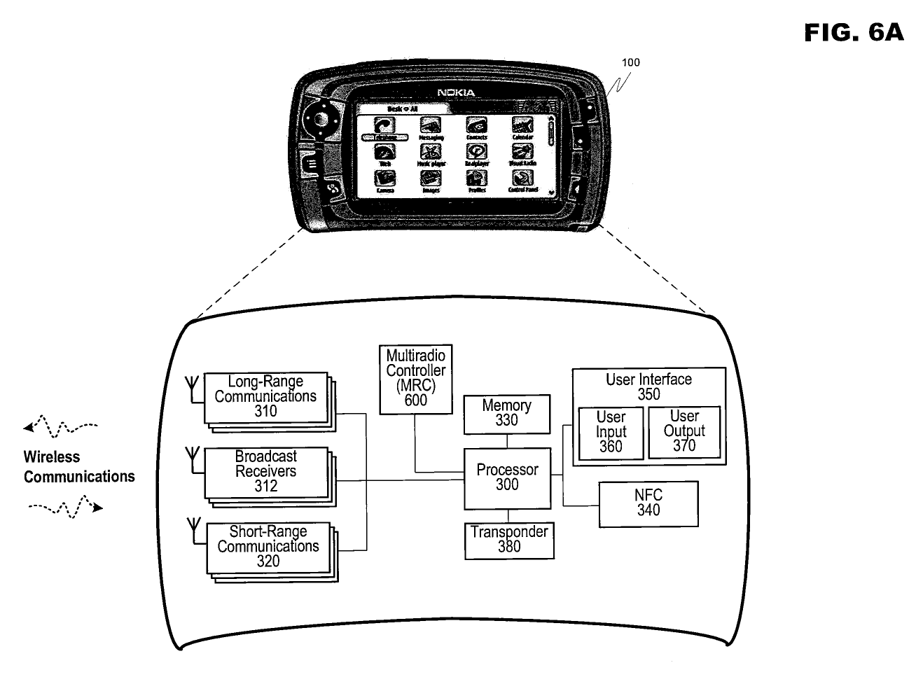

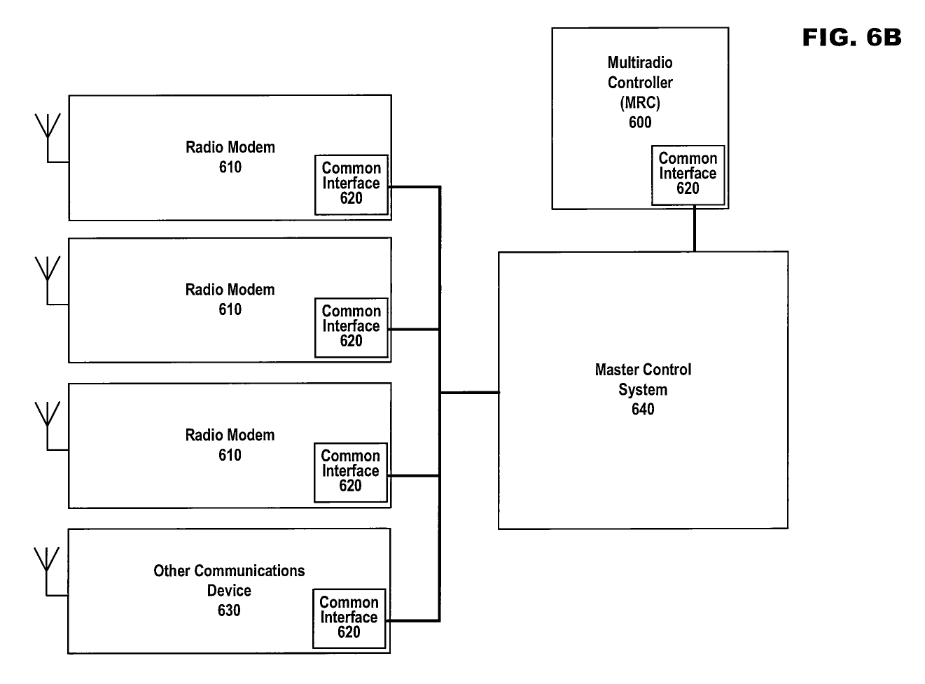

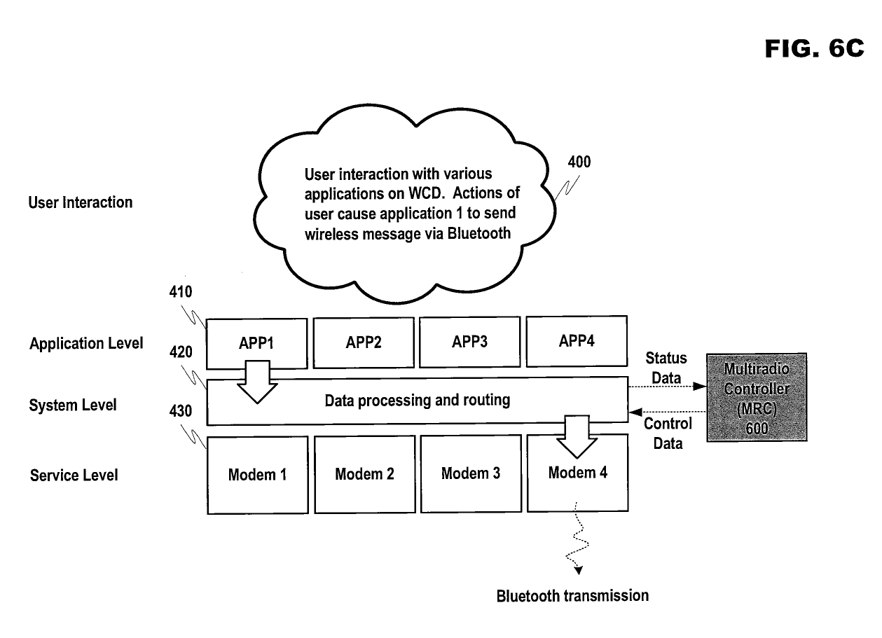

In an attempt to better manage communication in WCD 100, an additional controller dedicated to managing wireless communication may be introduced. WCD 100, as pictured in FIG. 6A, includes a multiradio controller (MRC) 600 in accordance with at least one embodiment of the present invention. MRC 600 may be coupled to the master control system of WCD 100. This configuration enables MRC 600 to communicate with radio modems or other similar devices in communications modules 310 312, 320 and 340 via the master operating system of WCD 100.

FIG. 6B discloses in detail at least one embodiment of WCD 100, which may include multiradio controller (MRC) 600 introduced in FIG. 6A in accordance with at least one embodiment of the present invention. MRC 600 may include common interface 620 by which information may be sent or received through master control system 640. Radio modems 610 and other devices 630 may also be referred to as “modules” in this disclosure as they may contain supporting hardware and/or software resources in addition to the radio modem itself. These resources may include control, interface and/or processing resources. For example, each radio modem 610 or similar communication device 630 (e.g., an RFID scanner for scanning machine-readable information) may also include some sort of common interface 620 for communicating with master control system 640. As a result, all information, commands, etc. that may occur between radio modems 610, similar devices 630 and MRC 600 are conveyed by communication resources in master control system 640. The possible effect of sharing communication resources with all the other functional modules within WCD 100 will be discussed with respect to FIG. 6C.

FIG. 6C discloses an operational diagram similar to FIG. 4 including the effect of MRC 600 in accordance with at least one embodiment of the present invention. In this system MRC 600 may receive operational data from master control system 640 concerning, for example, applications running in application level 410 and status data from various radio communication devices in service level 430. MRC 600 may use this information to issue scheduling commands to communication modules in service level 430 in an attempt to avoid communication problems. However, problems may occur when various operations in WCD 100 are active at the same time. Since applications in application level 410, operating system elements in system level 420, various communication modules in service level 430 and MRC 600 must all share the same common communication interface, bottlenecks may occur when all of these components of WCD 100 are trying to communicate simultaneously. As a result, delay sensitive information regarding both communication resource status information and radio module 610 control information may become delayed, nullifying the beneficial organizational effects of MRC 600.

### VI. A Wireless Communication Device Including a Multiradio Control System.

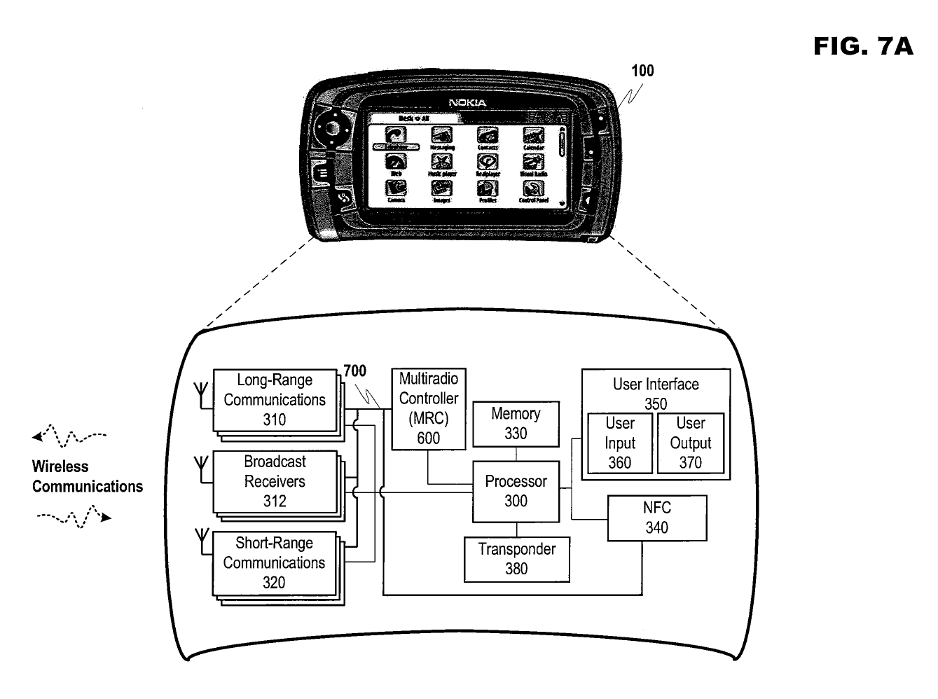

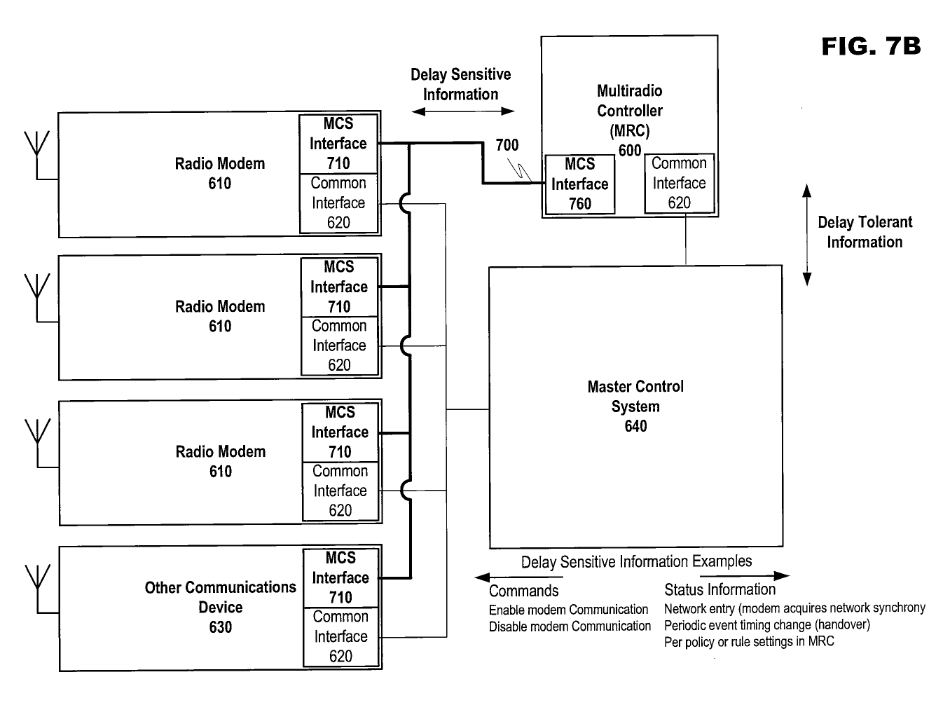

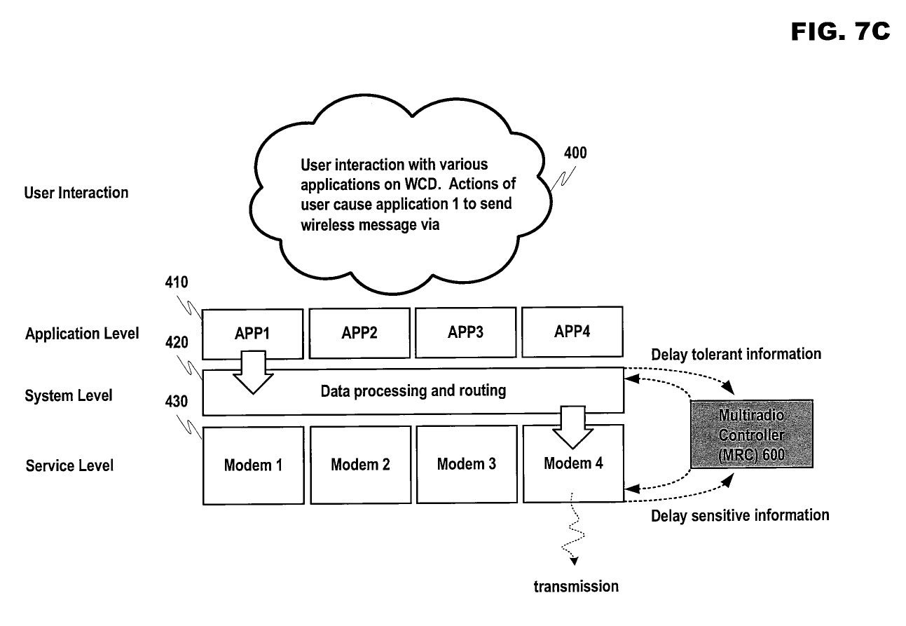

FIG. 7A introduces MRC 600 as part of exemplary multiradio control system (MCS) 700 in accordance with at least one embodiment of the present invention. MCS 700 directly links the communication resources of modules 310, 312, 320 and 340 to MRC 600 in WCD 100. MCS 700 may provide a dedicated low-traffic communication structure in WCD 100 for conveying delay sensitive information to and from MRC 600.

Additional detail is shown in FIG. 7B. MCS 700 may form a direct link between MRC 600 and the communication resources of WCD 100. This link may be established by a system of dedicated MCS interfaces 710 and 760. For example, MCS interface 760 may be coupled to MRC 600. MCS Interfaces 710 may connect radio modems 610 and other similar communication devices 630 to MCS 700 in order to form an information conveyance that allows delay sensitive information to travel to and from MRC 600. In this way, the capabilities of MRC 600 are no longer influenced by the processing load of master control system 640. Any information still communicated by master control system 640 to and from MRC 600 may be deemed delay tolerant, and therefore, the actual arrival time of this information does not substantially influence system performance. On the other hand, all delay sensitive information is directed to MCS 700, and therefore is insulated from the loading of the master control system.

An effect of MCS 700 in accordance with various embodiments of the present invention may be seen in FIG. 7C. Information may now be received into MRC 600 from at least two sources. System level 420 may continue to provide information to MRC 600 through master control system 640. In addition, service level 430 may specifically provide delay sensitive information conveyed by MCS 700. MRC 600 may distinguish between these two classes of information and act accordingly. Delay tolerant information may include information that typically does not change when a radio module is actively engaged in communication, such as radio mode information (e.g., GPRS, Bluetooth™, WLAN, etc.), priority information that may be defined by user settings, the specific service the radio is driving (QoS, real time/non real time), etc. Since delay tolerant information changes infrequently, it may be delivered in due course by master control system 640 of WCD 100. Alternatively, delay sensitive (e.g., time sensitive) information may include at least modem operational information that frequently changes during the course of a wireless connection, and therefore, requires immediate update. As a result, delay sensitive information may need to be delivered directly from the plurality of radio modules 610 through the MCS interfaces 710 and 760 to MRC 600, and may include radio module synchronization information. Delay sensitive information may be provided in response to a request by MRC 600, or may be delivered as a result of a change in radio module settings during transmission, as will be discussed with respect to synchronization below.

### VIII. A Wireless Communication Device Including a Distributed Multiradio Control System.

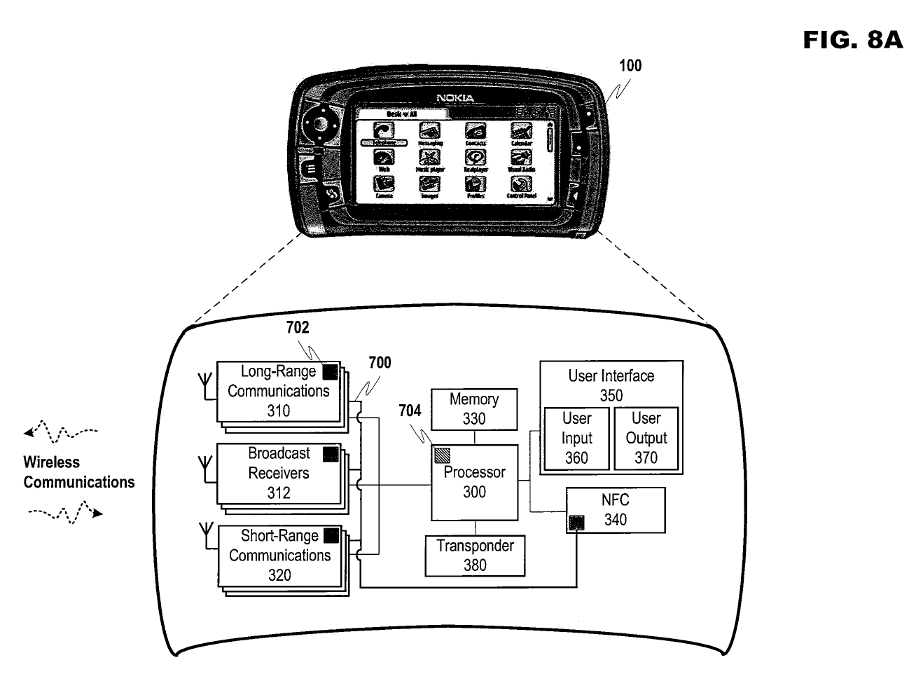

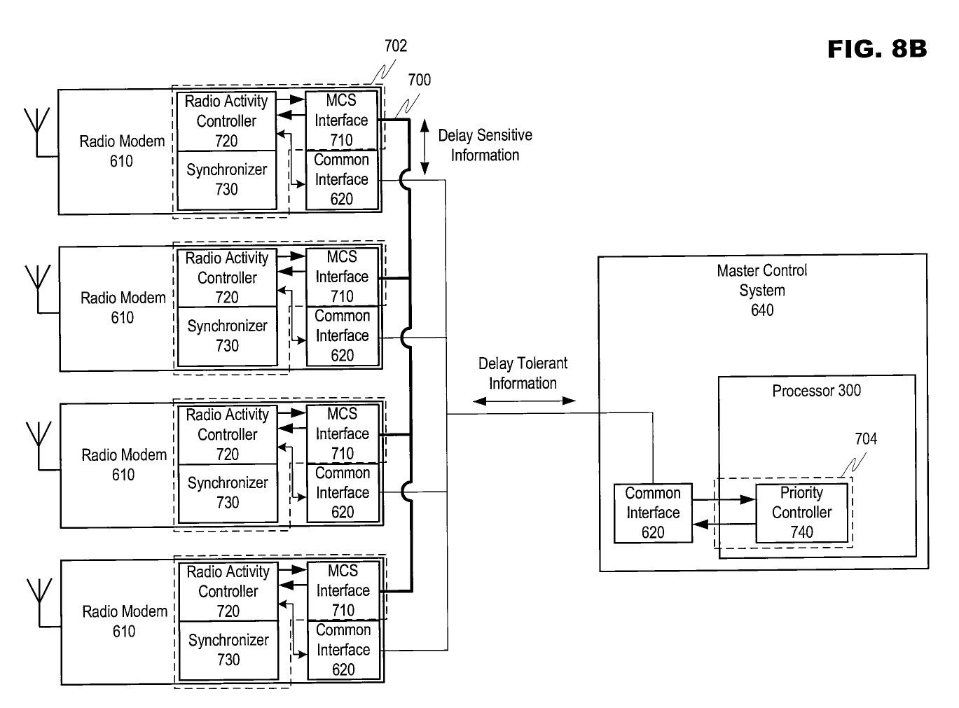

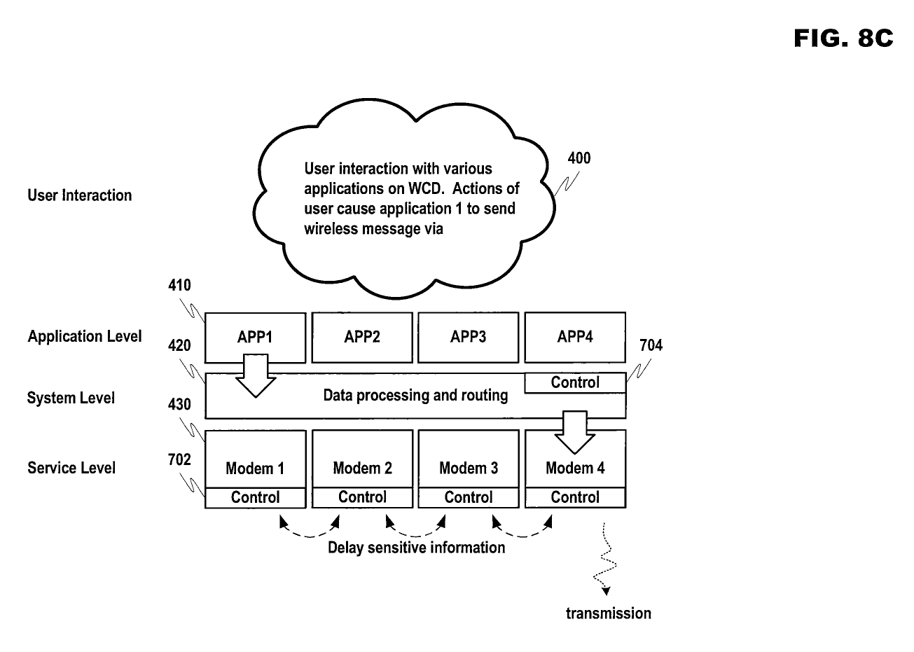

FIG. 8A discloses an alternative configuration of the present invention, in accordance with at least one embodiment, wherein a distributed version of multiradio control system (MCS) 700 may be implemented in WCD 100. Distributed MCS 700 may, in some instances, provide an advantage over a centralized MRC 600 architecture by distributing these control features into already necessary components in WCD 100. As a result, a substantial amount of communication management may be localized in various communication resources such as radio modules 610, reducing the total amount of control command traffic in WCD 100.

MCS 700 may be implemented utilizing a variety of bus structures such as, for example, the I²C interface commonly found in portable electronic devices, as well as emerging standards such as SLIMbus that are now under development. I²C is a multi-master bus, wherein multiple devices can be connected to the same bus and each one can act as a master through initiating a data transfer. An I²C bus contains at least two communication lines, an information line and a clock line. When a component has information to transmit, it assumes a master role and transmits both its clock signal and information to a recipient component. SLIMbus, on the other hand, utilizes a separate, non-differential physical layer that runs at rates of 50 Mbits/s or slower over just one lane. This architecture is being developed by the Mobile Industry Processor Interface (MIPI) Alliance to replace today's I²C and I²S interfaces while offering more features and requiring the same or less power than the two combined.

MCS 700 directly links distributed control components 702 in modules 310, 312, 320 and 340. Another distributed control component 704 may reside in master control system 640 of WCD 100. It is important to note that distributed control component 704 shown in processor 300 is not limited only to the specific configuration that has been disclosed in FIG. 8A, but may also reside in any appropriate system module within WCD 100. The addition of MCS 700 provides a dedicated low-traffic communication structure for carrying delay sensitive information both to and from the various distributed control components 702.

The exemplary configuration disclosed in FIG. 8A is described in more detail in FIG. 8B. MCS 700 may form a direct link between distributed control components 702 within WCD 100. Distributed control components 702 in radio modem 610 (together forming a “module”) may, for example, consist of MCS interface 710, radio activity controller 720 and synchronizer 730. Radio activity controller 720 uses MCS interface 710 to communicate with distributed control components in other radio modems 610. Synchronizer 730 may be utilized to obtain timing information from radio modem 610 to satisfy synchronization requests from any of the distributed control components 702. Radio activity controller 702 may also obtain information from master control system 640 (e.g., from distributed control component 704) through common interface 620. As a result, any information communicated by master control system 640 to radio activity controller 720 through common interface 620 may be deemed delay tolerant, and therefore, the actual arrival time of this information does not substantially influence communication system performance. On the other hand, all delay sensitive information may be conveyed by MCS 700, and therefore is insulated from master control system overloading.

Distributed control component 704 may exist within master control system 640. Some aspects of the component may reside in processor 300 as, for example, a running software routine that monitors and coordinates the behavior of radio activity controllers 720. Processor 300 is shown to contain priority controller 740. Priority controller 740 may be utilized to monitor active radio modems 610 in order to determine priority amongst these devices. Priority may be determined by rules and/or conditions stored in priority controller 740. Modems that become active may request priority information from priority controller 740. Further, modems that go inactive may notify priority controller 740 so that the priority of the remaining active radio modems 610 may be adjusted accordingly. Priority information is usually not considered delay sensitive because it is mainly updated when radio modems 610 activate/deactivate, and therefore, does not frequently change during the course of an active communication connection in radio modems 610. As a result, this information may be conveyed to radio modems 610 using common interface system 620 in at least one embodiment of the present invention.

An effect of distributed control MCS 700 is disclosed in FIG. 8C. System level 420 may continue to provide delay tolerant information to distributed control components 702 through master control system 640. In addition, distributed control components 702 in service level 430, such as modem activity controllers 720, may exchange delay sensitive information via MCS 700. Each distributed control component 702 may distinguish between these two classes of information and act accordingly. Delay tolerant information may include information that typically does not change when a radio modem is actively engaged in communication, such as radio mode information (e.g., GPRS, Bluetooth™, WLAN, etc.), priority information that may be defined by user settings, the specific service the radio is driving (QoS, real time/non real time), etc. Since delay tolerant information changes infrequently, it may be delivered in due course by master control system 640 of WCD 100. Alternatively, delay sensitive information may include at least modem operational information that frequently changes during the course of a wireless connection, and therefore, requires immediate update. Delay sensitive information may be delivered directly between distributed control components 702, and may include radio modem synchronization and activity control information. Delay sensitive information may be provided in response to a request, or may be delivered as a result of a change in a radio modem, which will be discussed with respect to synchronization below.

MCS interface 710 may be used to (1) Exchange synchronization information, and (2) Transmit identification or prioritization information between various radio activity controllers 720. Further, as previously stated, MCS interface 710 may be used to communicate radio parameters that are delay sensitive from a controlling point of view. MCS interface 710 can be shared between different radio modems (multipoint) but it cannot be shared with any other functionality that could limit the usage of MCS interface 710 from a latency point of view.

The control signals sent on MCS 700 that may enable/disable radio modem 610 should be built on a modem's periodic events. Each radio activity controller 720 may obtain this information about a radio modem's periodic events from synchronizer 730. This kind of event can be, for example, frame clock event in GSM (4.615 ms), slot clock event in Bluetooth™ (625 us) or targeted beacon transmission time in WLAN (100 ms) or any multiple of these. Radio modem 610 may send its synchronization indications when (1) Any radio activity controller 720 requests it, (2) a radio modem internal time reference is changed (e.g. due to handover/handoff). The latency requirement for the synchronization signal is not critical as long as the delay is constant within a few microseconds. Fixed delays may be taken into account in the scheduling logic of radio activity controller 710.

For predictive wireless communication mediums, radio modem activity control may be based on the knowledge of when the active radio modems 610 are about to transmit (or receive) in the specific connection mode in which the radios are currently operating. The connection mode of each radio modem 610 may be mapped to the time domain operation in their respective radio activity controller 720. For example, in a GSM speech connection priority controller 740 may have knowledge about all traffic patterns of GSM. This information may be transferred to an appropriate radio activity controller 720 when radio modem 610 becomes active, which may then recognize that a speech connection in GSM includes one transmission slot of length 577 μs, followed by an empty slot after which is the reception slot of 577 μs, two empty slots, monitoring (RX on), two empty slots, and then it repeats. Dual transfer mode means two transmission slots, empty slot, reception slot, empty slot, monitoring and two empty slots. When all traffic patterns that are known a priori by the radio activity controller 720, it only needs to know when the transmission slot occurs in time to gain knowledge of when the GSM radio modem is active. This information may be obtained by synchronizer 730. Every time the active radio modem 610 is about to transmit (or receive) it verifies whether the modem activity control signal from its radio activity controller 720 permits activity. Radio activity controller 720 may allow or disable transmission in increments of one full radio transmission block (e.g. GSM slot).

### IX. A Wireless Communication Device Including an Alternative Example of a Distributed Multiradio Control System.

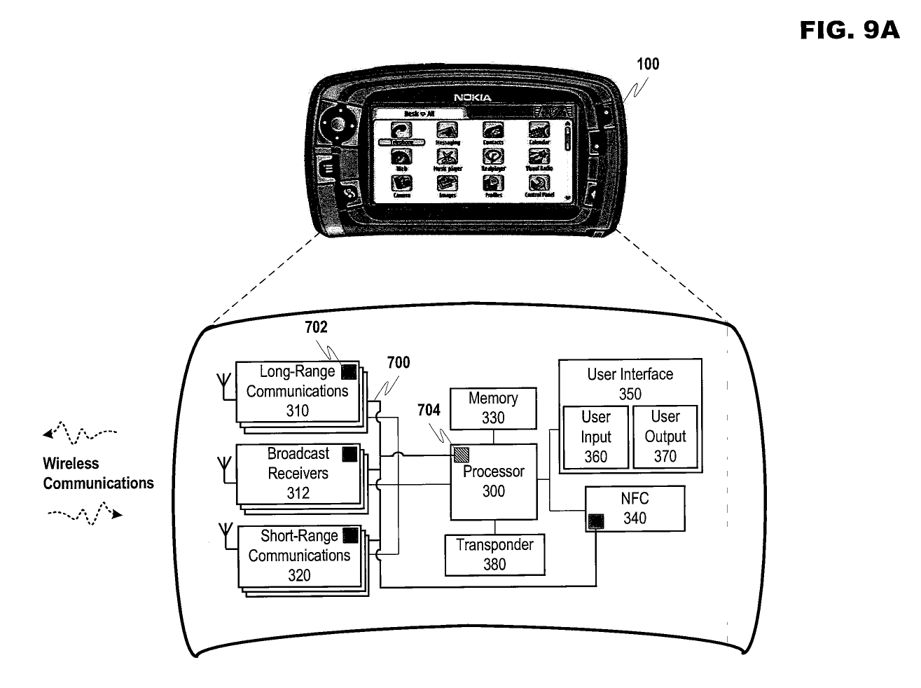

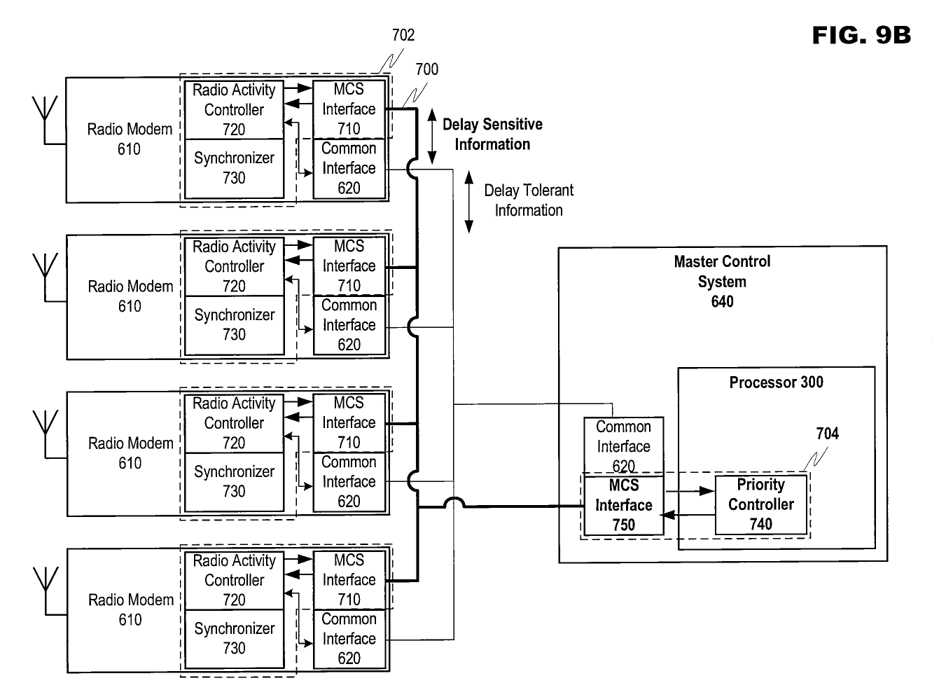

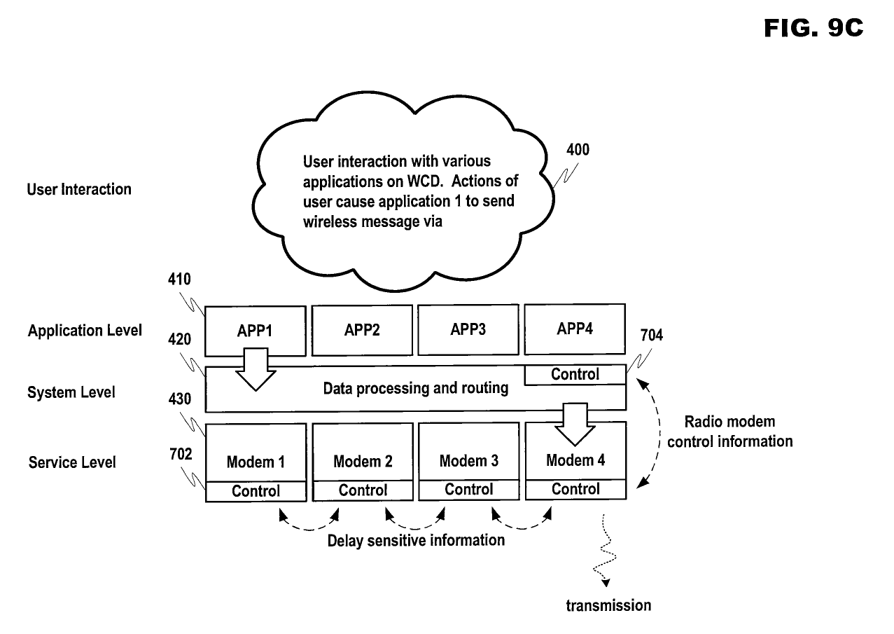

An alternative distributed control configuration in accordance with at least one embodiment of the present invention is disclosed in FIG. 9A-9C. In FIG. 9A, distributed control components 702 may still be linked by MCS 700. However, distributed control component 704 is now also directly coupled to distributed control components 702 via an MCS interface. As a result, distributed control component 704 may also benefit from MCS 700 in terms of delay-sensitive, and possibly some delay-tolerant, transactions involving components in WCD 100.

Referring now to FIG. 9B, the interfacing of distributed control component 704 into MCS 700 is shown in more detail. Distributed control component 704 may include at least priority controller 740 coupled to MCS interface 750. MCS interface 750 may allow priority controller 740 to send information to, and receive information from, radio activity controllers 720 via a low-traffic connection dedicated to the coordination of communication resources in WCD 100. As previously stated, the information provided by priority controller 740 may not be deemed delay sensitive information, however, the provision of priority information to radio activity controllers 720 via MCS 700 may improve the overall communication efficiency of WCD 100. Performance may improve because quicker communication between distributed control components 702 and 704 may result in faster relative priority resolution in radio activity controllers 720. Further, the common interface system 620 of WCD 100 may be relieved of having to accommodate communication traffic from distributed control component 704, reducing the overall communication load for master control system 640. Another benefit may be realized in communication control flexibility in WCD 100. New features may be introduced into priority controller 740 without worrying about whether the messaging between control components will be delay tolerant or sensitive because an MCS interface 710 is already available at this location.

FIG. 9C discloses at least one operational effect of the enhancements seen in the current alternative embodiment of the present invention on communication in WCD 100. The addition of an alternative route for radio modem control information to flow between distributed control components 702 and 704 may both improve the communication management of radio activity controllers 720 and may reduce the burden on master control system 640. In this embodiment, all distributed control components of MCS 700 are linked by a dedicated control interface, which may provide immunity to communication coordination control messaging in WCD 100 when the master control system 640 is experiencing elevated transactional demands.

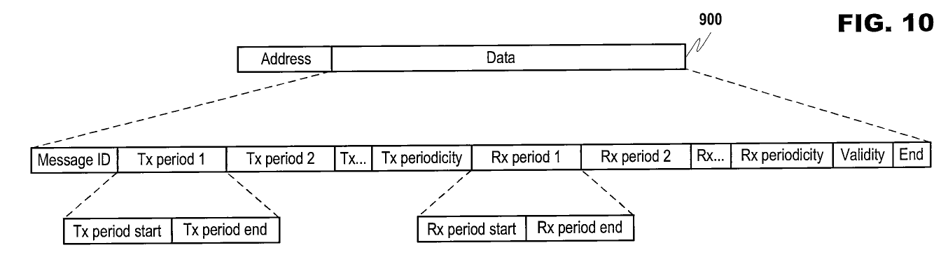

An example message packet 900 is disclosed in FIG. 10 in accordance with at least one embodiment of the present invention. Example message packet 900 includes activity pattern information that may be formulated by MRC 600 or radio activity controller 720. The data payload of packet 900 may include, in various embodiments of the present invention, at least Message ID information, allowed/disallowed transmission (Tx) period information, allowed/disallowed reception (Rx) period information, Tx/Rx periodicity (e.g., how often the Tx/Rx activities contained in the period information occur), and validity information describing when the activity pattern becomes valid and whether the new activity pattern is a replacement or being added to the existing one. The data payload of packet 900 may consist of multiple allowed/disallowed periods for transmission or reception (e.g., Tx period 1, 2 . . . ) each containing at least a period start time and a period end time during which radio modem 610 may be either permitted or prevented from executing communication activity. While exemplary distributed MCS 700 may allow for real-time radio modem control (e.g., more control messages with finer granularity), the ability to include multiple allowed/disallowed periods into a single message packet 900 may support radio activity controllers 720 in scheduling radio modem behavior for longer periods of time, which may reduce message traffic. Further, changes in radio modem 610 activity patterns may be amended using the validity information in each message packet 900.

The modem activity control signal (e.g., packet 900) may be formulated by MRC 600 or radio activity controller 720 and transmitted on MCS 700. The signal includes activity periods for Tx and Rx separately, and the periodicity of the activity for radio modem 610. While the native radio modem clock may be the controlling time domain (never overwritten), the time reference utilized in synchronizing the activity periods to current radio modem operation may be based on one of at least two standards. In a first example, a transmission period may start after a pre-defined amount of synchronization events have occurred in radio modem 610. Alternatively, all timing for MRC 600, or between distributed control components 702, may be standardized around the system clock for WCD 100. Advantages and disadvantages exist for both solutions. Using a defined number of modem synchronization events may be beneficial because all timing may be closely aligned with the radio modem clock. However, this may be more complicated to implement than basing timing on the system clock. On the other hand, while timing based on the system clock may be easier to implement as a standard, conversion to modem clock timing must necessarily be implemented whenever a new activity pattern is introduced to radio modem 610.

The activity period may be indicated as start and stop times. If there is only one active connection, or if there is no need to schedule the active connections, the modem activity control signal may be set always on allowing the radio modems to operate without restriction. Radio modem 610 may verify whether the transmission or reception is allowed before attempting actual communication. The activity end time can be used to check the synchronization. Once the radio modem 610 has ended the transaction (slot/packet/burst), it can check whether the activity signal is still set (e.g., it should be due to margins). If this is not the case, radio modem 610 can initiate a new synchronization with MRC 600 or with radio activity controller 720 through synchronizer 730. This process may also occur if a radio modem time reference or connection mode changes. Problems may manifest if radio activity controller 720 becomes unsynchronized and starts to apply modem transmission/reception restrictions at the wrong time, and therefore, modem synchronization signals need to be updated periodically. Higher accuracy is required in the synchronization information when more wireless connections are active.

### X. Radio Modem Interface to Other Devices.

As a part of information acquisition services, MCS interface 710 may send information to MRC 600 (or radio activity controllers 720) about periodic events of the radio modems 610. Using MCS interface 710; radio modem 610 may indicate a time instance of a periodic event related to its operation. In practice these instances may be times when radio modem 610 is active and may be preparing to communicate or is communicating. Events occurring prior to, or during a, transmission or reception mode may be used as a time reference (e.g., in case of GSM, the frame edge may be indicated in a modem that is not necessarily transmitting or receiving at that moment, but we know based on the frame clock that the modem is going to transmit [x]ms after the frame clock edge). Basic principle for timing indications is that the event is periodic in nature. Every incident does not need to be indicated, because MRC 600 may calculate intermediate incidents. In order for this to occur, other relevant information about the event would be required (e.g. periodicity and duration). This information may be either embedded in the indication, or the controller may get it by other means. Most importantly, these timing indications need to be such that the controller can acquire a radio modem's basic periodicity and timing. The timing of an event may either be in the indication itself, or it may be implicitly derived from the indication information by MRC 600 (or radio activity controller 720).

Timing indications generally need to be provided on periodic events like: schedule broadcasts from a base station (typically TDMA/MAC frame boundaries) and own periodic transmission or reception periods (typically Tx/Rx slots). Those notifications need to be issued by radio modem 610: (1) on network entry (i.e. modem acquires network synchrony), (2) on periodic event timing change e.g. due to a handoff or handover, and (3) as per the policy and configuration settings in the multiradio controller (either monolithic or distributed).

In at least one embodiment of the present invention, messages exchanged between the aforementioned communication components in WCD 100 may be used to dictate behavior on both a local (e.g., radio modem level) and global (e.g., apparatus level) basis. MRC 600 or radio activity controller 720 may deliver a schedule to radio modem 610 with the intent of controlling that specific modem. However, radio modem 610 may not be forced to conform to this schedule. A basic principle of the present invention, in accordance with at least one embodiment, is that radio modem 610 not only operates in accordance with multiradio control information (e.g., operates when MRC 600 permits) but may also perform internal scheduling and link adaptation while taking the MRC-formulated schedule information into account.

### XI. Interference Reporting.

Close proximity signal activity can cause periodic or continuous degradation in IEEE 802.11 (WLAN) device performance. To remedy this situation, the IEEE 802.11v specification proposes to introduce co-located interference (CLI) reporting to WLAN, wherein an apparatus may provide information concerning co-located interference being experienced on an operating channel to another apparatus. The received interference information may then be utilized by the requesting device in managing interactions with the reporting device in a manner that limits the effect of the interference. However, CLI reporting, taken by itself, is strictly a reactive strategy.

While WLAN will be discussed below for the sake of explanation in the present disclosure, the use of WLAN as an exemplary wireless communication medium is only because this functionality is currently being considered for emerging versions of WLAN, and in no way limits the present invention to only this specific wireless transport. The present invention, in accordance with at least one embodiment, may be applied to any wireless communication medium that may be configured to support interference reporting such as, for example, co-located interference reporting (CLI) as discussed herein, or any related or similar functionality.

Apparatuses that support interference reporting functionality, for example, as proposed for IEEE 802.11v (hereafter, “WLAN”), may set an interference reporting capability flag to notify other apparatuses. In terms of WLAN, the Co-located interference reporting (CLI) bit in the extended capabilities element may be set to 1. A requesting apparatus may request CLI reporting from another apparatus by sending a CLI request containing a unique dialog token. The remote apparatus, if it accepts the request, may then return a CLI response frame including a dialog token that matches the one in the CLI request frame. A report sent by a non-access point (AP) apparatus may use a unicast frame. A report sent by an AP may use a broadcast frame.

Alternatively, a requesting apparatus may request that automatic CLI reporting be enabled at remote apparatuses that have indicated support for CLI reporting capability. To enable automatic CLI reporting, a requesting apparatus may send a CLI request frame with Automatic Response Enabled bit set to 1. Change events may then occur, for example, when CLI is detected, when the level of CLI changes significantly, when the periodicity of CLI changes, or when the CLI is no longer present. The requesting apparatus can disable automatic reporting by sending a CLI Request frame with the Automatic Response Enabled field set to 0.

A remote apparatus that accepts a request for automatic CLI reporting may send a CLI response frame to the requesting apparatus if it detects that CLI is causing performance degradation to its WLAN receiver. The dialog token field may be set to the nonzero value received in the CLI request frame which was used to enable automatic responses. The remote apparatus may then send CLI response frames with an interval indicated by the report period field or if the CLI level is changing significantly or if the time characteristics of the interference is significantly changing. The remote apparatus may not generate CLI responses with greater frequently than indicated by the report timeout field in the CLI request. New CLI requests supersede any previously received CLI request sent by the same apparatus as a new CLI request.

Remote apparatuses may use the Interference Index field in CLI response frame to identify different types of interference. For example, if a remote apparatus has knowledge of two different forms of CLI, the remote apparatus may report both types of interference using separate response info fields having separate interference index fields. Both response info fields can be sent in the same CLI response frame and both can have the same report period. Remote apparatuses may report any CLI determined to be causing degradation in its performance. The characteristics of the interference are known a priori without interference detection and characterization by the WLAN apparatus. Methods used by a remote apparatus to obtain the information on the periodicity, level of interference, accuracy of the reported interference level, interference center frequency and interference bandwidth are outside the scope of this standard. Automatic CLI reporting in a remote apparatus may be terminated on receipt of a CLI request frame in the remote apparatus wherein the automatic response bit is set to 0. Upon receipt, the remote apparatus(es) may continue to act independently to account for locally sensed interference, but will no longer send CLI reporting information to the requesting apparatus.

XII. Exemplary Interference Reporting Integration with Multiradio Management.

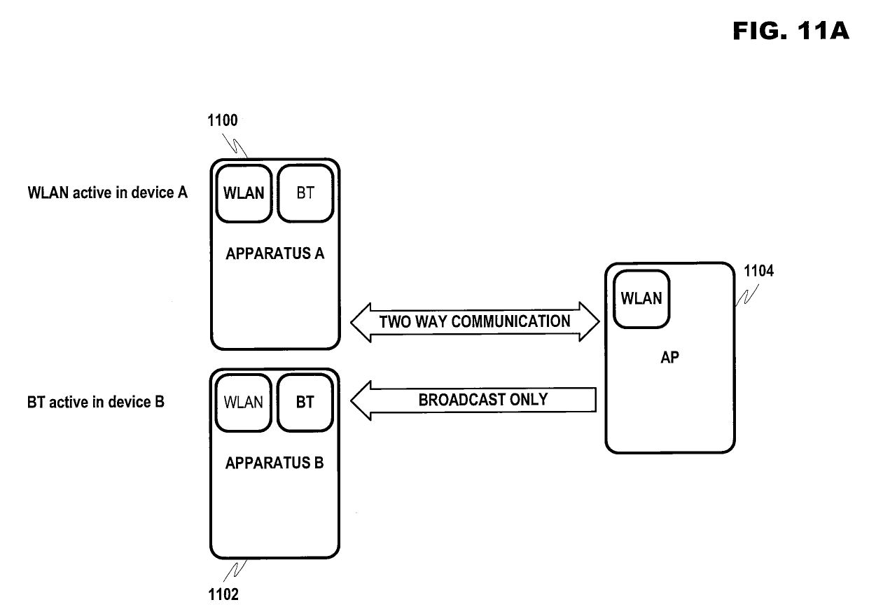

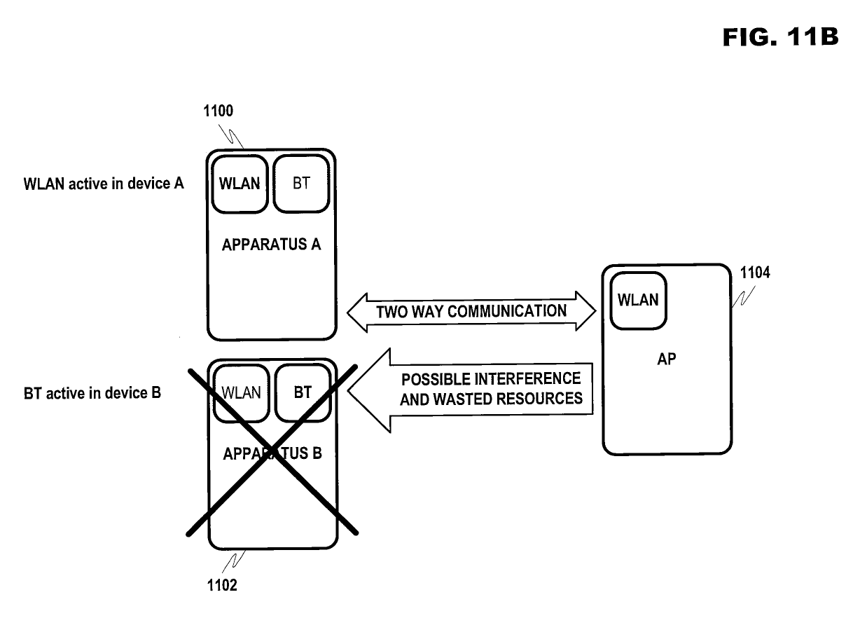

Now referring to FIG. 11A, an exemplary wireless communication scenario is disclosed. Two example apparatuses (1100 and 1102) are shown that include one or more radio modules that support at least Bluetooth™ (“BT”) and WLAN. At the particular instance shown, Apparatus A 1100 is communicating with AP 1104 via WLAN while Apparatus B 1102 may actively be communicating via another wireless communication medium (e.g., Bluetooth™).

AP 1104 broadcasts messages to all devices that have established links with the access point, whether or not the device is actively communicating using WLAN. As a result, the broadcasts to Apparatus A 1100 results in bidirectional or two-way communication, while the messages packets to Apparatus B 1102 remain unanswered since this apparatus is actively communicating in another medium (or is at least not actively communicating in WLAN at this instance). The impact of this situation without the implementation of at least one embodiment of the present invention is shown in FIG. 11B. While apparatus A 1100 is able to communicate with AP 1104, the messages to apparatus B 1102 may negatively impact both the remote apparatus and the AP. The WLAN messages sent to device B 1102 are additional traffic in the same operational bandwidth as Bluetooth™, and therefore, may in turn become interference for the active Bluetooth™ radio. This interference may cause Bluetooth™ packets to become lost, requiring retransmission and a possible decline in Bluetooth™ performance. This impact on QoS may force apparatus B 1102 to expend additional resources (e.g., processing, energy, etc.) when compensating for the interference, and as a result, these resources may be consumed more quickly, which can lead to serious problems for handheld devices. In addition, AP 1104 is also wasting resources in sending messages to an apparatus that will not respond (e.g., where no WLAN resources are active). This may be a particularly burdensome where resources are limited. For example, in a situation where the access point is powered by a battery that limits power resources, or where a lot of devices are requesting communicating connections. This may occur, for example, in an area where an AP is providing public wireless access to the Internet.

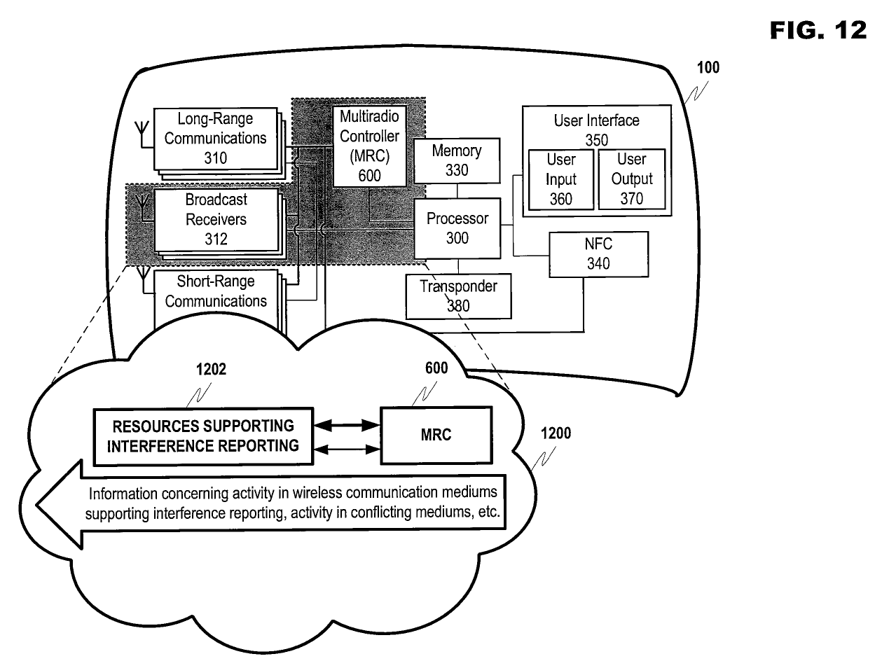

Various embodiments of the present invention may avoid interference problems by indicating that transmission in a wirelessly linked apparatus may be temporarily disabled (e.g., AP 1104 in the example of FIG. 11B) when no communication requirements are pending for the linked apparatus. As shown in FIG. 12 at 1200, a centralized or distributed MRC 600 may be configured to provide information to resources supporting interference reporting 1202 regarding scheduled operations in WCD 100. These operations may be based on, for example, operational schedules formulated by MRC 600 for active wireless communication mediums in WCD 100. The information provided to interference reporting resources 1202 may be based on periods when the operational schedule indicates that, for example, a wireless communication medium will be allowed to operate (or prevented from operating), or conversely, on periods of time where possibly conflicting wireless communication mediums have scheduled operation. In the exemplary case where operational scheduling regarding conflicting mediums is provided to interference reporting resources 1202, this information may used to in turn determine when a wireless communication medium that supports interference reporting will not be active.

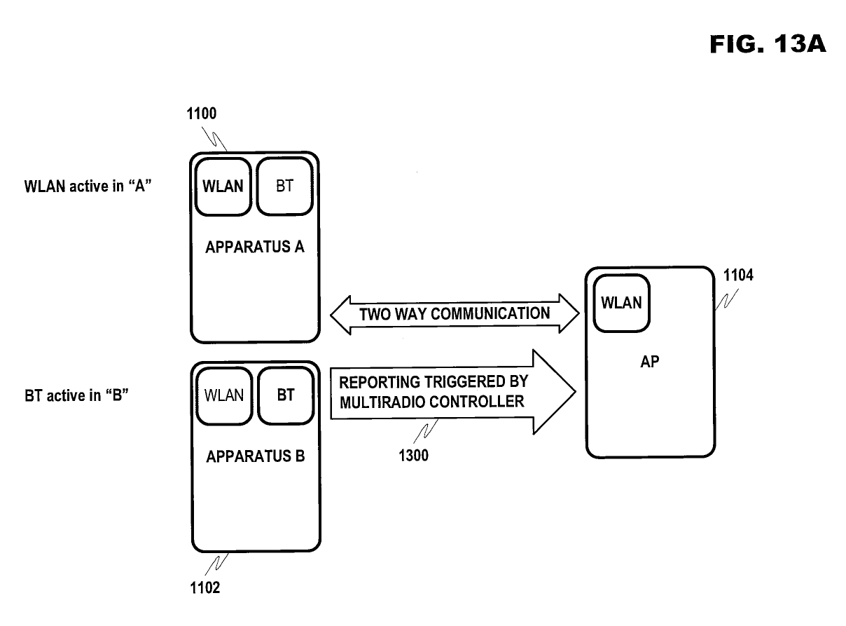

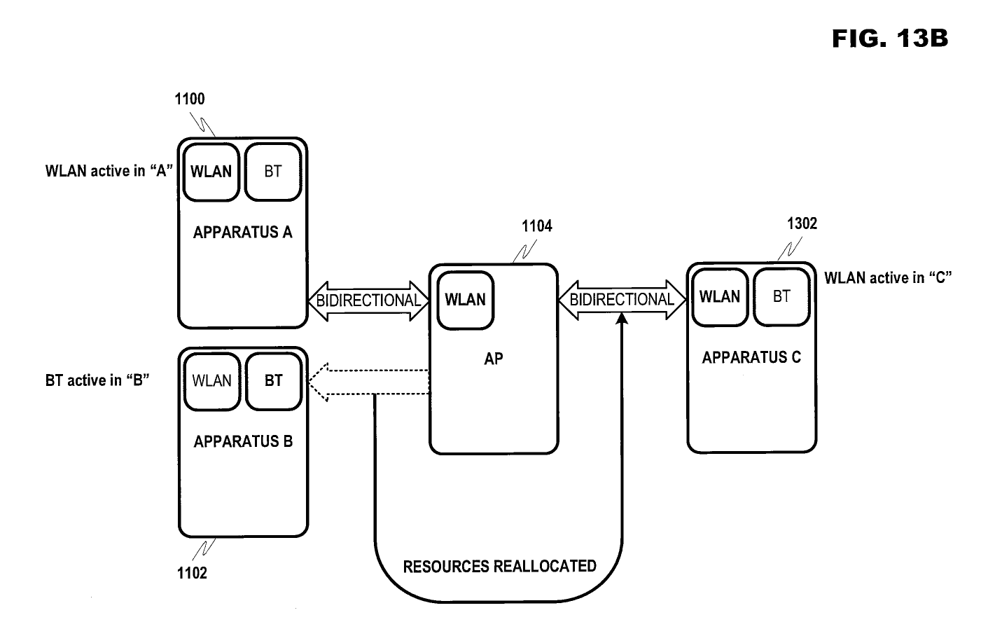

FIG. 13A discloses an example similar to FIG. 12A in that Apparatus A 1100 is actively communicating using a wireless communication medium supporting interference reporting and device B, while linked to AP 1104 over the same wireless medium, has no pending messages for transmission. However, in this situation MRC 600 may trigger interference reporting resources 1202 in apparatus B 1102 to send interference reporting to AP 1104. Again, interference reporting may be triggered in accordance with the operational schedule of the wireless communication medium that supports interference reporting (e.g., WLAN) or based on the operational schedules of any active wireless communication mediums that may conflict with the medium supporting interference reporting. The reporting 1300 that is sent may reflect that interference exists during the time periods where the wireless communication medium will not be active. The proximally located interference may be unidentified when reported to AP 1104, or may be identified based on the operational schedule in apparatus B 1102. More specifically, if a wireless communication medium is active during a period when the wireless communication medium supporting interference reporting is inactive, this information may be sent to AP 1104.

FIG. 13B shows a potential effect of reporting planned wireless communication medium activity via interference reporting, or alternatively, planned activity of conflicting wireless communication mediums in apparatus B 1102, in accordance with various embodiments of the present invention. AP 1104 may not attempt to communicate with apparatus B 1102 via the wireless communication medium supporting interference reporting during periods indicating inactivity in the apparatus, even though AP 1104 may have pending information for apparatus B 1102, due to the received interference reporting. As a result, the amount of possibly conflicting communication in a bandwidth may be minimized. This may in turn improve the overall QoS of Bluetooth™ in apparatus B 1102. Further, since resources are not being wasted in sending messages to a recipient apparatus that will not respond (e.g., apparatus B 1102), these resources may be reallocated to other devices that may desired to communicate with AP 1104 during this time period (e.g., apparatus C 1302 in FIG. 13B). In this way, interference may be minimized in apparatus B 1102 while resource management (and efficiency) may be improved in AP 1102.

Apparatus B 1102 may report interference information to AP 1104 that, for example, may indicate one or more periods of inactivity. In view of this information also being available in apparatus B 1102, resources internal to the apparatus may be reallocated (e.g., by MRC 600) for use by other radio modules, even though a wireless association with AP 1104 may be continually maintained during inactive periods. For example, in a situation where different wireless communication mediums and/or radio modules share physical resources, these resources may be made available for use by other wireless communication mediums and/or radio modules.

In at least one embodiment of the present invention, the network-level resource usage (spectrum/time) may be diverted from unavailable wireless communication mediums and/or radio modules (that may indicate unavailability via interference reporting) to available wireless communication mediums and/or radio modules. Exemplary radio modules 610 may include reconfigurable hardware that is shared between different radio systems (e.g., Bluetooth™ and WLAN may share the same physical resources). This configuration may be implemented, for example, in a software defined radio (SDR) platform. SDR systems might share, for example, general purpose processors, signal processors, hardware accelerators, radio frequency circuit blocks, memory, communication buses, etc. Some of these shared resources (notably RF blocks, but also others to some extent) cannot be used by multiple radio systems at the same time, sand therefore, the usage of these resources must be shared between various consumers. Acquisition (and subsequent release) of shared resources for the use in various embodiments the present invention may be orchestrated by, for example, the aforementioned operational schedule.

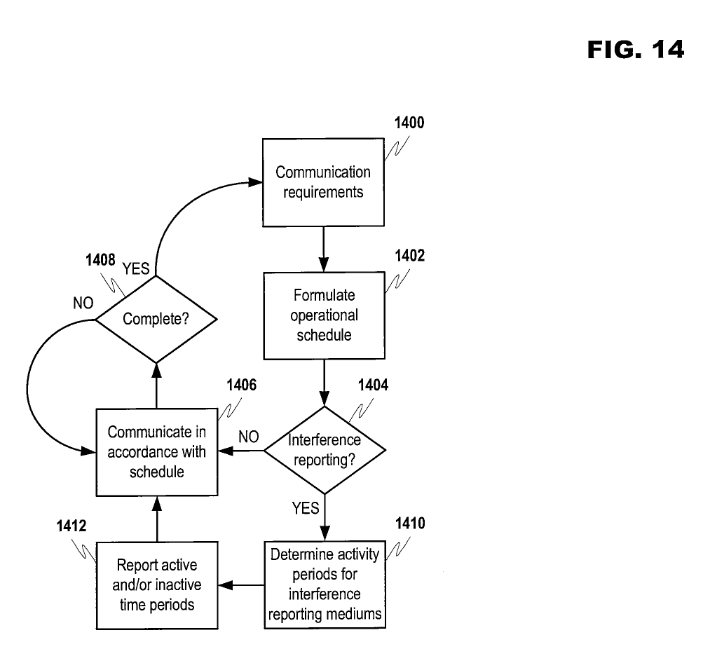

Now referring to FIG. 14, a flowchart of an exemplary process in accordance with at least one embodiment of the present invention is now disclosed. In step 1400 an apparatus may realize that communication requirements exist in one or more time periods. Some of these communication requirements may pertain to wireless communication mediums that support interference reporting, such as the co-located interference (CLI) reporting proposed in WLAN. In this example WLAN generally represents wireless communication mediums with interference reporting, and therefore, various embodiments of the present invention discussed herein are not limited to WLAN, but may be implemented with any medium supporting interference reporting.

In step 1402, a centralized or distributed MRC may formulate one or more operational schedules pertaining to the wireless communication mediums supported in the device. A determination may then be made in step 1404 as to whether any active wireless communication mediums supports interference reporting, such as the exemplary scenario in which WLAN supports co-located interference (CLI) reporting. If no mediums support this functionality, then in step 1406 communication in the apparatus may proceed in accordance with the operational schedules formulated by an MRC and may continue in step 1408 until complete, whereupon the process may return to step 1400 to await additional communication requirements.

If any active wireless communication medium supports interference reporting, then in step 1410 periods of activity and inactivity may be determined in view of the operational scheduling devised the MRC. Again, these periods may be periods of activity based on an operational schedule for the wireless communication mediums supporting interference reporting, or may be inactivity periods in view of the operational schedule for possibly conflicting wireless communication mediums. Periods of inactivity may then be reported out to another apparatus (in the previous examples the other apparatus was an AP). Communication may then proceed in the apparatus in accordance with the schedule in step 1406. However, the AP or other apparatus communicating using wireless communication mediums supporting interference reporting may avoid attempts at communicating over these wireless communication mediums during periods of operation that were previously reported as having interference due to, for example, inactivity or in view of other possibly conflicting wireless communication mediums in the apparatus.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
scheduling operation for at least one wireless communication medium in an apparatus supporting a plurality of wireless communication mediums;
determining one or more activity periods for a wireless communication medium supporting interference reporting based on the operational schedule of the at least one wireless communication medium in the apparatus; and
communicating information related to the one or more activity periods via the wireless communication medium supporting interference reporting.

2. The method of claim 1, wherein the one or more activity periods are times when operation of the wireless communication medium supporting interference reporting is permitted.

3. The method of claim 1, wherein the one or more activity periods are times when operation of the wireless communication medium supporting interference reporting is not permitted.

4. The method of claim 3, wherein the one or more activity periods are times when those of the plurality of wireless communication mediums that conflict with the wireless communication medium supporting interference reporting are scheduled to operate.

5. The method of claim 1, wherein resources used by the wireless communication medium supporting interference reporting are reallocated during the one or more activity periods.

6. The method of claim 1, wherein the information related to the one or more activity periods is communicated to a remote apparatus that is wirelessly linked to the apparatus via the wireless communication medium supporting interference reporting.

7. The method of claim 6, wherein the remote apparatus attempts to communicate with, or avoids communicating with, the apparatus via the wireless communication medium supporting interference reporting during the one or more activity periods.

8. The method of claim 1, wherein the interference reporting comprises reporting interference caused by at least one co-located wireless communication medium.

9. The method of claim 1, wherein the wireless communication medium supporting interference reporting is WLAN supporting co-located interference reporting (CLI).

10. A computer program product comprising a computer usable medium having computer readable program code embodied in said medium, comprising:
a computer readable program code configured to schedule operation for at least one wireless communication medium in an apparatus supporting a plurality of wireless communication mediums;
a computer readable program code configured to determine one or more activity periods for a wireless communication medium supporting interference reporting based on the operational schedule of the at least one wireless communication medium in the apparatus; and
a computer readable program code configured to communicate information related to the one or more activity periods via the wireless communication medium supporting interference reporting.

11. The computer program product of claim 10, wherein the one or more activity periods are times when operation of the wireless communication medium supporting interference reporting is permitted.

12. The computer program product of claim 10, wherein the one or more activity periods are times when operation of the wireless communication medium supporting interference reporting is not permitted.

13. The computer program product of claim 12, wherein the one or more activity periods are times when those of the plurality of wireless communication mediums that conflict with the wireless communication medium supporting interference reporting are scheduled to operate.

14. The computer program product of claim 10, wherein resources used by the wireless communication medium supporting interference reporting are reallocated during the one or more activity periods.

15. The computer program product of claim 10, wherein the information related to the one or more activity periods is communicated to a remote apparatus that is wirelessly linked to the apparatus via the wireless communication medium supporting interference reporting.

16. The computer program product of claim 15, wherein the remote apparatus attempts to communicate with, or avoids communicating with, the apparatus via the wireless communication medium supporting interference reporting during the one or more activity periods.

17. The computer program product of claim 10, wherein the interference reporting comprises reporting interference caused by at least one co-located wireless communication medium.

18. The computer program product of claim 10, wherein the wireless communication medium supporting interference reporting is WLAN supporting co-located interference reporting (CLI).

19. An apparatus, comprising:
at least one communication module, and
a processor, the processor being configured to:
schedule operation for at least one wireless communication medium;
determine one or more activity periods for a wireless communication medium supporting interference reporting based on the operational schedule of the at least one wireless communication medium in the apparatus; and
communicate information related to the one or more activity periods via the wireless communication medium supporting interference reporting.

20. The apparatus of claim 19, wherein the at least one communication module supports a plurality of wireless communication mediums.

21. The apparatus of claim 19, wherein the one or more activity periods are times when operation of the wireless communication medium supporting interference reporting is permitted.

22. The apparatus of claim 19, wherein the one or more activity periods are times when operation of the wireless communication medium supporting interference reporting is not permitted.

23. The apparatus of claim 22, wherein the one or more activity periods are times when those of the plurality of wireless communication mediums that conflict with the wireless communication medium supporting interference reporting are scheduled to operate.

24. The apparatus of claim 19, wherein resources used by the wireless communication medium supporting interference reporting are reallocated during the one or more activity periods.

25. The apparatus of claim 19, wherein the information related to the one or more activity periods is communicated to a remote apparatus that is wirelessly linked to the apparatus via the wireless communication medium supporting interference reporting.

26. The apparatus of claim 25, wherein the remote apparatus attempts to communicate with, or avoids communicating with, the apparatus via the wireless communication medium supporting interference reporting during the one or more activity periods.

27. The apparatus of claim 19, wherein the interference reporting comprises reporting interference caused by at least one co-located wireless communication medium.

28. The apparatus of claim 19, wherein the wireless communication medium supporting interference reporting is WLAN supporting co-located interference reporting (CLI).

29. An apparatus, comprising:
means for scheduling operation for at least one wireless communication medium in an apparatus supporting a plurality of wireless communication mediums;
means for determining one or more activity periods for a wireless communication medium supporting interference reporting based on the operational schedule of the at least one wireless communication medium in the apparatus; and
means for communicating information related to the one or more activity periods via the wireless communication medium supporting interference reporting.

30. A method, comprising:
scheduling operation for at least one wireless communication medium in an apparatus supporting a plurality of wireless communication mediums;
determining one or more activity periods for wireless local area network (WLAN) medium supporting co-located interference (CLI) reporting based on the operational schedule; and
reporting the one or more activity periods via the WLAN CLI to another apparatus.

31. A computer program product comprising a computer usable medium having computer readable program code embodied in said medium, comprising:
a computer readable program code configured to schedule operation for at least one wireless communication medium in an apparatus supporting a plurality of wireless communication mediums;
a computer readable program code configured to determine one or more activity periods for wireless local area network (WLAN) medium supporting co-located interference (CLI) reporting based on the operational schedule; and
a computer readable program code configured to report the one or more activity periods via the WLAN CLI to another apparatus.

32. An apparatus, comprising:
at least one communication module, and
a processor, the processor being configured to:
schedule operation for at least one wireless communication medium in an apparatus supporting a plurality of wireless communication mediums;
determine one or more activity periods for wireless local area network (WLAN) medium supporting co-located interference (CLI) reporting based on the operational schedule; and
report the one or more activity periods via the WLAN CLI to another apparatus.

33. An apparatus, comprising:
means for scheduling operation for at least one wireless communication medium in an apparatus supporting a plurality of wireless communication mediums;
means for determining one or more activity periods for wireless local area network (WLAN) medium supporting co-located interference (CLI) reporting based on the operational schedule; and
means for reporting the one or more activity periods via the WLAN CLI to another apparatus.

34. A system, comprising:
a remote apparatus configured to support a plurality of wireless communication mediums; and
an access point
the remote apparatus scheduling operation for at least one wireless communication medium;
the remote apparatus determining one or more activity periods for a wireless communication medium supporting interference reporting based on the operational schedule of the at least one wireless communication medium in the remote apparatus; and
the remote apparatus communicating information related to the one or more activity periods via the wireless communication medium supporting interference reporting to the access point.
